(19) United States
(12) Patent Application Publication
(10) Pub. No.: US 2024/0376957 A1
(43) Pub. Date: Nov. 14, 2024

(54) DAMPING FORCE GENERATION MECHANISM

(71) Applicant: Hitachi Astemo, Ltd., Ibaraki (JP)

(72) Inventors: Mikio YAMASHITA, Hitachinaka-shi (JP); Takamasa KOTANI, Hitachinaka-shi (JP); Seiryo KONAKAI, Hitachinaka-shi (JP)

(21) Appl. No.: 18/690,354

(22) PCT Filed: Sep. 13, 2022
(86) PCT No.: PCT/JP2022/034162

§ 371 Date: Mar. 8, 2024

(30) Foreign Application Priority Data
Sep. 15, 2021 (JP) 2021-150023

(51) Int. Cl. F16F 9/504; F16F 9/32; F16F 9/348; F16F 9/36

(52) U.S. Cl. CPC F16F 9/504; F16F 9/3214; F16F 9/348; F16F 9/368; F16F 2222/12; F16F 2228/04; F16F 2228/066; F16F 2230/30

(57) ABSTRACT

A damping force generation mechanism (190) includes: a biasing force generation member (91) that causes a first damping force generation member (203) having a bottomed tubular shape and disposed on a side of an opening (145) to generate a biasing force in a valve closing direction; a regulation member (18) that is provided on a side of a bottom portion (92) of the biasing force generation member (91) and includes passages (43, 44) formed to establish communication between a one-side chamber and an other-side chamber (20); a frequency sensitive mechanism (191) that is provided between the regulation member (18) and the first damping force generation member (203), is provided with a movable portion (171) in a movable manner, and makes the biasing force variable; and a seat forming member (205) that is provided at the biasing force generation member (91) on the side of the opening (145) and includes a seat (233) formed therein for the first damping force generation member (203) to be seated.

### TECHNICAL FIELD

The present invention relates to a damping force generation mechanism.

Priority is claimed on Japanese Patent Application No. 2021-150023, filed Sep. 15, 2021, the content of which is incorporated herein by reference.

### BACKGROUND ART

There are buffers including damping force generation mechanisms having variable damping forces in response to frequencies (see Patent Literature 1 and 2, for example).

### CITATION LIST

### Patent Literature

### [Patent Literature 1]

International Publication No. WO 2018/163868

### [Patent Literature 2]

Japanese Translation of PCT International Application Publication No. 2018-533703

### Summary of Invention

### Technical Problem

Size reduction of a damping force generation mechanism is required.

An object of the present invention is to provide a damping force generation mechanism that enables size reduction.

### Solution to Problem

According to a first aspect of the present invention, there is provided a damping force generation mechanism including: a biasing force generation member that causes a first damping force generation member having a bottomed tubular shape and disposed on a side of an opening to generate a biasing force in a valve closing direction; a regulation member that is provided on a side of a bottom portion of the biasing force generation member and includes a passage formed to establish communication between a one-side chamber and an other-side chamber; a frequency sensitive mechanism that is provided between the regulation member and the first damping force generation member, is provided with a movable portion in a movable manner, and makes the biasing force variable; and a seat forming member that is provided at the biasing force generation member on the side of the opening and includes a seat formed therein for the first damping force generation member to be seated.

### Advantageous Effects of Invention

According to the present invention, it is possible to achieve size reduction of the damping force generation mechanism.

### BRIEF DESCRIPTION OF DRAWINGS

FIG. 1 is a front view illustrating a buffer including a damping force generation mechanism according to a first embodiment in a partial cross section.

FIG. 2 is a partial sectional view illustrating the damping force generation mechanism according to the first embodiment.

FIG. 3 is a one-side sectional view illustrating the damping force generation mechanism according to the first embodiment.

FIG. 4 is a hydraulic circuit diagram of a peripheral part of a piston of the buffer including the damping force generation mechanism according to the first embodiment.

FIG. 5 is a one-side sectional view illustrating a damping force generation mechanism according to a second embodiment.

FIG. 6 is a one-side sectional view illustrating a damping force generation mechanism according to a third embodiment.

FIG. 7 is a hydraulic circuit diagram of a peripheral part of a piston of a buffer including the damping force generation mechanism according to the third embodiment.

FIG. 8 is a one-side sectional view illustrating a damping force generation mechanism according to a fourth embodiment.

FIG. 9 is a one-side sectional view illustrating a damping force generation mechanism according to a fifth embodiment.

FIG. 10 is a one-side sectional view illustrating a damping force generation mechanism according to a sixth embodiment.

FIG. 11 is a one-side sectional view illustrating a damping force generation mechanism according to a seventh embodiment.

FIG. 12 is a one-side sectional view illustrating a damping force generation mechanism according to an eighth embodiment.

FIG. 13 is a one-side sectional view illustrating a damping force generation mechanism according to a ninth embodiment.

FIG. 14 is a one-side sectional view illustrating a damping force generation mechanism according to a tenth embodiment.

FIG. 15 is a one-side sectional view illustrating a damping force generation mechanism according to an eleventh embodiment.

### DESCRIPTION OF EMBODIMENTS

### First Embodiment

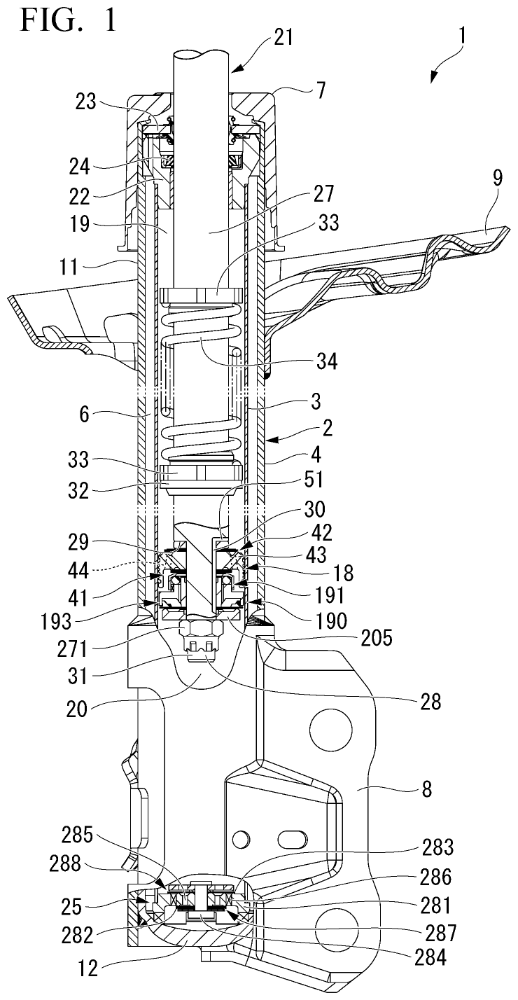

A buffer (shock absorber) including a damping force generation mechanism according to a first embodiment will be described below with reference to FIGS. 1 to 4. Note that the following description will be given on the assumption that the upper side in FIGS. 1 to 3, 5, 6, and 8 to 15 corresponds to “up” and the lower side in FIGS. 1 to 3, 5, 6, and 8 to 15 corresponds to “down” for convenience of explanation.

FIG. 1 is a diagram illustrating a buffer 1 including a damping force generation mechanism 190 according to the first embodiment. The buffer 1 is a so-called two-way hydraulic buffer. The buffer 1 includes a cylinder 2 in which an oil liquid (not illustrated) as a working fluid is sealed. The cylinder 2 includes an inner tube 3 and an outer tube 4. The inner tube 3 has a cylindrical shape. The outer tube 4 has a bottomed cylindrical shape. An inner diameter of the outer tube 4 is larger than an outer diameter of the inner tube 3. The inner tube 3 is disposed inside the outer tube 4. A center axis of the inner tube 3 coincides with a center axis of the outer tube 4. A reservoir chamber 6 is provided between the inner tube 3 and the outer tube 4. The buffer 4 includes a cover 7, a main bracket 8, and a spring seat 9. The cover 7 covers the outer tube 4 on an upper opening side. Both the main bracket 8 and the spring seat 9 are fixed to an outer peripheral portion of the outer tube 4.

The outer tube 4 includes a trunk portion 11 and a cylinder bottom portion 12. The trunk portion 11 has a cylindrical shape. The cylinder bottom portion 12 is provided at a lower portion of the trunk portion 11. The cylinder bottom portion 12 blocks the lower portion of the trunk portion 11. The trunk portion 11 and the cylinder bottom portion 12 are seamlessly and integrally molded from one material.

The buffer 1 includes a piston 18 (regulation member). The piston 18 is fitted into the inner tube 3 of the cylinder 2. The piston 18 is slidable in an axial direction of the cylinder 2 with respect to the cylinder 2. In other words, the piston 18 is movably inserted into the inside of the cylinder 2. The piston 18 sections the inside of the inner tube 3 into two chambers, namely an upper chamber 19 (one-side chamber) and a lower chamber 20 (other-side chamber). An oil liquid serving as a working fluid is sealed inside the upper chamber 19 and inside the lower chamber 20. An oil liquid serving as a working fluid and a gas are sealed in the reservoir chamber 6 between the inner tube 3 and the outer tube 4.

The buffer 1 includes a piston rod 21 (shaft member). The piston rod 21 is disposed with one end side thereof in the axial direction located inside the inner tube 3 of the cylinder 2. The piston rod 21 is coupled to the piston 18 on the one end side. The piston rod 21 on the other end side on the side opposite to the one end side in the axial direction extends from the cylinder 2 to the outside of the cylinder 2. The piston 18 is fixed to the piston rod 21. Therefore, the piston 18 and the piston rod 21 move integrally. A process of the buffer 1 in which the piston rod 21 moves in a direction in which the amount of projection from the cylinder 2 increases is an extending process in which the total length extends. A process of the buffer 1 in which the piston rod 21 moves in a direction in which the amount of projection from the cylinder 2 decreases is a contracting process in which the total length contracts. The piston 18 of the buffer 1 moves toward the upper chamber 19 in the extending process. The piston 18 of the buffer 1 moves toward the lower chamber 20 in the contracting process.

A rod guide 22 is fitted on the side of the upper end opening of the inner tube 3 and on the side of the upper end opening of the outer tube 4. A seal member 23 is fitted into the outer tube 4 further upward than the rod guide 22. A friction member 24 is provided between the rod guide 22 and the seal member 23. All of the rod guide 22, the seal member 23, and the friction member 24 have annular shapes. The piston rod 21 is inserted into the inside of each of the rod guide 22, the friction member 24, and the seal member 23. The piston rod 21 slides in the axial direction of the rod guide 22, the friction member 24, and the seal member 23 with respect to them. The piston rod 21 extends further outward from the cylinder 2 than the seal member 23 from the inside of the cylinder 2.

The rod guide 22 restricts movement of the piston rod 21 in a radial direction with respect to the inner tube 3 and the outer tube 4 of the cylinder 2. The piston rod 21 is fitted into the rod guide 22, and the piston 18 is fitted into the inner tube 3. In this manner, a center axis of the piston rod 21 coincides with a center axis of the cylinder 2. In other words, the piston rod 21 is provided along the center axis of the cylinder 2 by the piston 18 fixed to the one end side in the axial direction and the rod guide 22 supporting an intermediate part. The rod guide 22 supports the piston rod 21 such that the piston rod 21 is movable in the axial direction of the piston rod 21. An outer peripheral portion of the seal member 23 comes into close contact with the outer tube 4. An inner peripheral portion of the seal member 23 comes into close contact with the outer peripheral portion of the piston rod 21. The piston rod 21 moves in the axial direction of the seal member 23 with respect to the seal member 23. The seal member 23 curbs leakage of the oil liquid inside the inner tube 3 and high-pressure gas and the oil liquid inside the reservoir chamber 6 to the outside. An inner peripheral portion of the friction member 24 comes in contact with the outer peripheral portion of the piston rod 21. The piston rod 21 moves in the axial direction of the friction member 24 with respect to the friction member 24. The friction member 24 causes friction resistance against the piston rod 21.

The outer peripheral portion of the rod guide 22 has a larger diameter at an upper portion than at a lower portion. The rod guide 22 is fitted into the inner peripheral portion at the upper end of the inner tube 3 at the lower portion with the smaller diameter. The rod guide 22 is fitted into the inner peripheral portion at the upper portion of the outer tube 4 at the upper portion with the larger diameter. A base valve 25 is installed on the cylinder bottom portion 12 of the outer tube 4. The base valve 25 is positioned in the radial direction with respect to the outer tube 4. The base valve 25 performs sectioning between the lower chamber 20 and the reservoir chamber 6. The inner peripheral portion at the lower end of the inner tube 3 is fitted into the base valve 25. The upper end portion of the outer tube 4 is swaged on the inner side in the radial direction of the outer tube 4. The seal member 23 is sandwiched and fixed between the swaged part and the rod guide 22.

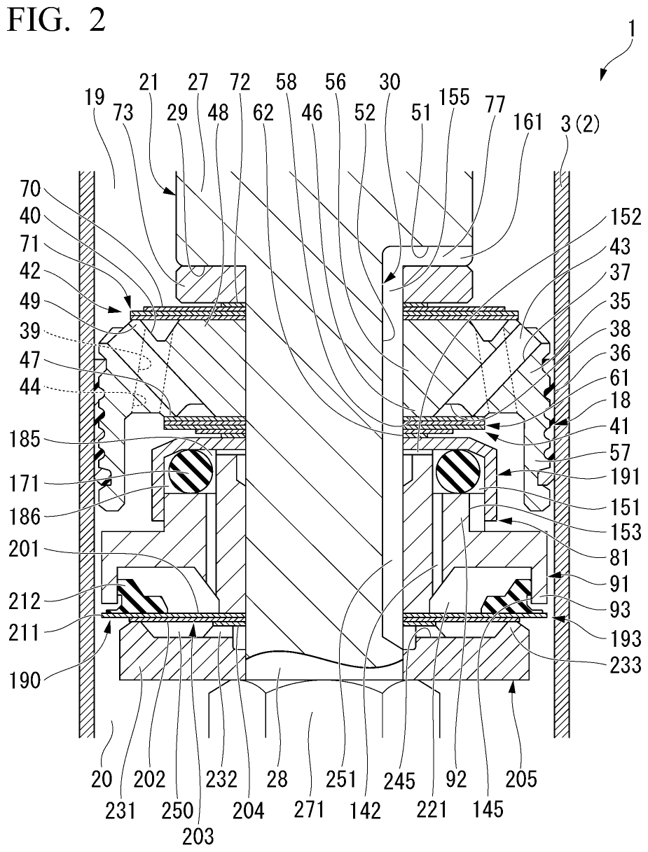

The piston rod 21 includes a main shaft portion 27 and an attachment shaft portion 28. An outer diameter of the attachment shaft portion 28 is smaller than an outer diameter of the main shaft portion 27. The attachment shaft portion 28 is disposed inside the cylinder 2. The piston 18 is attached to the attachment shaft portion 28. The main shaft portion 27 includes a shaft step portion 29. The shaft step portion 29 is provided at an end portion of the main shaft portion 27 on the side of the attachment shaft portion 28. The shaft step portion 29 spreads in a direction perpendicularly intersecting the center axis of the piston rod 21. As illustrated in FIG. 2, a passage groove 30 is formed in the piston rod 21 from the shaft step portion 29 to the outer peripheral portion of the attachment shaft portion 28. The passage groove 30 includes a groove portion 51 and a groove portion 52. The groove portion 51 is formed in the shaft step portion 29. The groove portion 51 extends in the radial direction of the shaft step portion 29. The groove portion 52 is formed in the attachment shaft portion 28. The groove portion 52 extends in the axial direction of the attachment shaft portion 28. The groove portion 51 and the groove portion 52 are continuously provided. As illustrated in FIG. 1, a male screw 31 is formed at the outer peripheral portion at an end portion of the attachment shaft portion 28 on the side opposite to the main shaft portion 27 as compared with the passage groove 30 in the axial direction of the attachment shaft portion 28. The groove portion 51 of the passage groove 30 formed in the shaft step portion 29 opens in the upper chamber 19.

The piston rod 21 is provided with a stopper member 32 with an annular shape, a pair of buffering bodies 33 with annular shapes, and a coil spring 34. All of the stopper member 32, the pair of buffering bodies 33, and the coil spring 34 are provided between the piston 18 of the main shaft portion 27 and the rod guide 22. The piston rod 21 is inserted into the stopper member 32 on the inner peripheral side. The stopper member 32 is swaged and fixed to the main shaft portion 27. One of the buffering bodies 33, the coil spring 34, and the other buffering body 33 are disposed in the main shaft portion 27 in that order from the side of the stopper member 32 closer to the rod guide 22 than the stopper member 32. The pair of buffering bodies 33 and the coil spring 34 are disposed between the stopper member 32 and the rod guide 22.

In the buffer 1, a part of the piston rod 21 projecting from the cylinder 2, for example, is disposed at an upper portion and is coupled to a vehicle body. At this time, the main bracket 8 of the buffer 1 provided on the side of the cylinder 2 is disposed at a lower portion and is coupled to the vehicle on the wheel side. The buffer 1 may be coupled to the vehicle body on the side of the cylinder 2 in the opposite manner. In this case, the piston rod 21 of the buffer 1 is coupled on the wheel side.

In the vehicle, wheels oscillate with respect to the vehicle body while traveling. When this happens, the relative positions of the cylinder 2 and the piston rod 21 in the buffer 1 change with the oscillation. The changes are curbed by fluid resistance of a flow path provided in the buffer 1. The fluid resistance of the flow path provided in the buffer 1 is designed to differ depending on the speed and the amplitude of the aforementioned oscillation as will be described later in detail. Comfort in the vehicle is improved by the buffer 1 curbing the oscillation.

Also, an inertial force and a centrifugal force generated in the vehicle body during travel of the vehicle also act between the cylinder 2 and the piston rod 21 in the vehicle in addition to the oscillation generated by the wheels with respect to the vehicle body. A centrifugal force is generated in the vehicle body by changing the traveling direction in response to a steering wheel operation, for example. When this happens, a force based on the centrifugal force acts between the cylinder 2 and the piston rod 21. The buffer 1 has a satisfactory characteristic with respect to the oscillation based on the force generated in the vehicle body during travel of the vehicle as will be described later. The buffer 1 enables the vehicle to obtain high traveling stability.

As illustrated in FIG. 2, the piston 18 includes a piston main body 35 and a sliding member 36. The piston main body 35 is made of a metal and is seamlessly and integrally formed. The piston main body 35 has an annular shape and is formed by sintering. The piston main body 35 of the piston 18 is fitted to the attachment shaft portion 28 of the piston rod 21. The sliding member 36 is made of a synthetic resin and has an annular shape. The sliding member 36 is integrally attached to the outer peripheral surface of the piston main body 35. The sliding member 36 of the piston 18 slides with respect to the inner tube 3 while in contact with the inner tube 3.

The piston main body 35 includes a main body base portion 56 and a main body tubular portion 57. The main body base portion 56 and the main body tubular portion 57 in the piston main body 35 are seamlessly and integrally formed. The main body base portion 56 has a circular plate shape. The main body tubular portion 57 has a tubular shape and extends on one side in the axial direction of the main body base portion 56 from the outer peripheral portion of the main body base portion 56. The piston main body 35 on the side of the main body tubular portion 57 in the axial direction of the main body base portion 56 and on the inner peripheral side of the main body tubular portion 57 form a recessed portion 58. The recessed portion 58 is recessed in the axial direction of the piston main body 35 from one end of the piston main body 35 in the axial direction. Therefore, the piston 18 includes the recessed portion 58 that has a smaller axial direction dimension in a predetermined range on the inner side in the radial direction than in the other ranges. The main body tubular portion 57 of the piston main body 35 extends on the side of the lower chamber 20 from the main body base portion 56. The sliding member 36 is attached across both the outer peripheral portions of the main body base portion 56 and the main body tubular portion 57.

The main body base portion 56 of the piston main body 35 is provided with passage holes 37, a passage groove 38, passage holes 39, and a passage groove 40. The passage holes 37 penetrate through the main body base portion 56 in the axial direction of the main body base portion 56. The plurality of passage holes 37 are formed in the main body base portion 56 at intervals in a circumferential direction of the main body base portion 56. The passage holes 39 penetrate through the main body base portion 56 in the axial direction of the main body base portion 56. The plurality of passage holes 39 are formed in the main body base portion 56 at intervals in the circumferential direction of the main body base portion 56. The passage holes 37 and the passage holes 39 are alternately formed in the main body base portion 56 at equal pitches one by one at each location in a peripheral direction of the main body base portion 56.

The passage groove 38 is formed into an annular shape in the circumferential direction of the main body base portion 56 in the main body base portion 56. The passage groove 38 is formed at one end portion of the main body base portion 56 on the side of the main body tubular portion 57 in the axial direction. End portions of all the passage holes 37 on the side of the main body tubular portion 57 in the axial direction of the main body base portion 56 open in the passage groove 38. The passage groove 40 is formed into an annular shape in the circumferential direction of the main body base portion 56 in the main body base portion 56. The passage groove 40 is formed at the other end portion on the side opposite to the main body tubular portion 57 in the axial direction of the main body base portion 56. The end portions of all the passage holes 39 on the side opposite to the main body tubular portion 57 in the axial direction of the main body base portion 56 open in the passage groove 40. End portions of the plurality of passage holes 37 on the side opposite to the passage groove 38 in the axial direction of the main body base portion 56 open further outward than the passage groove 40 in the radial direction of the main body base portion 56. End portions of the plurality of passage holes 39 on the side opposite to the passage groove 40 in the axial direction of the main body base portion 56 open further outward than the passage groove 38 in the radial direction of the main body base portion 56. For the piston 18, the inside of the plurality of passage holes 37 and the inside of the passage groove 38 serve as a piston passage 43 (passage). For the piston 18, the inside of the plurality of passage holes 39 and the inside of the passage groove 40 serve as a piston passage 44.

The buffer 1 includes a damping force generation unit 41 provided in the piston passage 43 of the piston 18. The damping force generation unit 41 opens and closes the piston passage 43 and generates a damping force. The damping force generation unit 41 is provided in the piston 18 on the side of the lower chamber 20 in the axial direction of the piston 18. The piston passage 43 serves as a passage through which an oil liquid flows out from the upper chamber 19 toward the lower chamber 20 in movement of the piston 18 toward the upper chamber 19. In other words, the piston passage 43 serves as a passage on the extending side on which the oil liquid flows out from the upper chamber 19 toward the lower chamber 20 in the extending process of the buffer 1. The damping force generation unit 41 is a damping force generation unit on the extending side on which flowing of the oil liquid in the piston passage 43 is curbed and a damping force is generated.

The buffer 1 includes a damping force generation mechanism 42 provided in the piston passage 44 of the piston 18. The damping force generation mechanism 42 opens and closes the piston passage 44 and generates a damping force. The damping force generation mechanism 42 is provided in the piston 18 on the side of the upper chamber 19 in the axial direction of the piston 18. The piston passage 44 serves as a passage from which the oil liquid flows out from the lower chamber 20 toward the upper chamber 19 in movement of the piston 18 toward the lower chamber 20. In other words, the piston passage 44 serves as a passage on a contraction side on which the oil liquid flows out from the lower chamber 20 toward the upper chamber 19 in the contracting process of the buffer 1. The damping force generation mechanism 42 serves as a damping force generation mechanism on the contraction side on which flowing of the oil liquid in the piston passage 44 is curbed and a damping force is generated.

The piston passage 43 establishes communication such that the oil liquid flows between the upper chamber 19 and the lower chamber 20 with movement of the piston 18. In other words, the piston passage 43 is formed in the piston 18 and establishes communication between the upper chamber 19 and the lower chamber 20. The piston passage 44 establishes communication such that the oil liquid flows between the lower chamber 20 and the upper chamber 19 with movement of the piston 18. In other words, the piston passage 44 is formed in the piston 18 and establishes communication between the upper chamber 19 and the lower chamber 20. The oil liquid passes through the piston passage 43 when the piston rod 21 and the piston 18 move to the extending side (the upper side in FIG. 2). The oil liquid passes through the piston passage 44 when the piston rod 21 and the piston 18 move to the contraction side (the lower side in FIG. 2). The piston main body 35 allows the attachment shaft portion 28 of the piston rod 21 to be fitted into the inner peripheral portion of the main body base portion 56 with an annular shape.

An inner seat portion 46 and a valve seat portion 47 are formed at an end portion of the main body base portion 56 on the side of the lower chamber 20 in the axial direction further inward in the radial direction than the main body tubular portion 57. The inner seat portion 46 has an annular shape. The valve seat portion 47 also has an annular shape. The inner seat portion 46 is disposed further inward in the radial direction of the main body base portion 56 than the opening of the passage groove 38 on the side of the lower chamber 20. The valve seat portion 47 is disposed further outward in the radial direction of the main body base portion 56 than the opening of the passage groove 38 on the side of the lower chamber 20. The valve seat portion 47 is a part of the damping force generation unit 41.

An inner seat portion 48 and a valve seat portion 49 are formed at an end portion of the main body base portion 56 on the side of the upper chamber 19 in the axial direction, that is, at an end portion of the piston main body 35 on the side of the upper chamber 19 in the axial direction. The inner seat portion 48 has an annular shape. The valve seat portion 49 also has an annular shape. The inner seat portion 48 is disposed further inward in the radial direction of the main body base portion 56 than the opening of the passage groove 40 on the side of the upper chamber 19. The valve seat portion 49 is disposed further outward in the radial direction of the main body base portion 56 than the opening of the passage groove 40 on the side of the upper chamber 19. The valve seat portion 49 is a part of the damping force generation mechanism 42.

Openings in all the passage holes 39 on the side of the lower chamber 20 are disposed in the main body base portion 56 on the side opposite to the passage groove 38 of the valve seat portion 47 in the radial direction of the main body base portion 56. Openings of all the passage holes 37 on the side of the upper chamber 19 are disposed in the main body base portion 56 on the side opposite to the passage groove 40 of the valve seat portion 49 in the radial direction of the main body base portion 56.

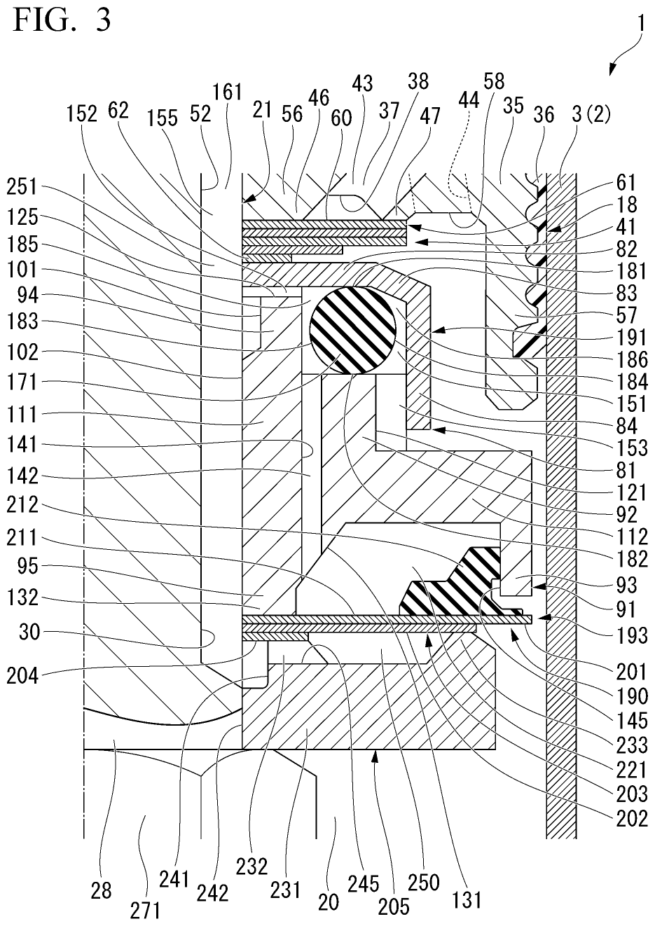

As illustrated in FIG. 3, a hard valve 61 including a plurality of discs 60 is provided in the main body base portion 56 on the side of the lower chamber 20 in the axial direction. One intervening disc 62 is provided on the side opposite to the main body base portion 56 in the axial direction of the hard valve 61. All of the intervening disc 62 and the plurality of discs 60 are made of metal. All of the intervening disc 62 and the plurality of discs 60 have flat plate shapes with constant thicknesses and have annular shapes. All of the intervening disc 62 and the plurality of discs 60 are formed through press molding from plate materials. All of the intervening disc 62 and the plurality of discs 60 allow the attachment shaft portion 28 of the piston rod 21 to be fitted on the inner peripheral side. An outer diameter of the intervening disc 62 is smaller than outer diameters of all the plurality of discs 60.

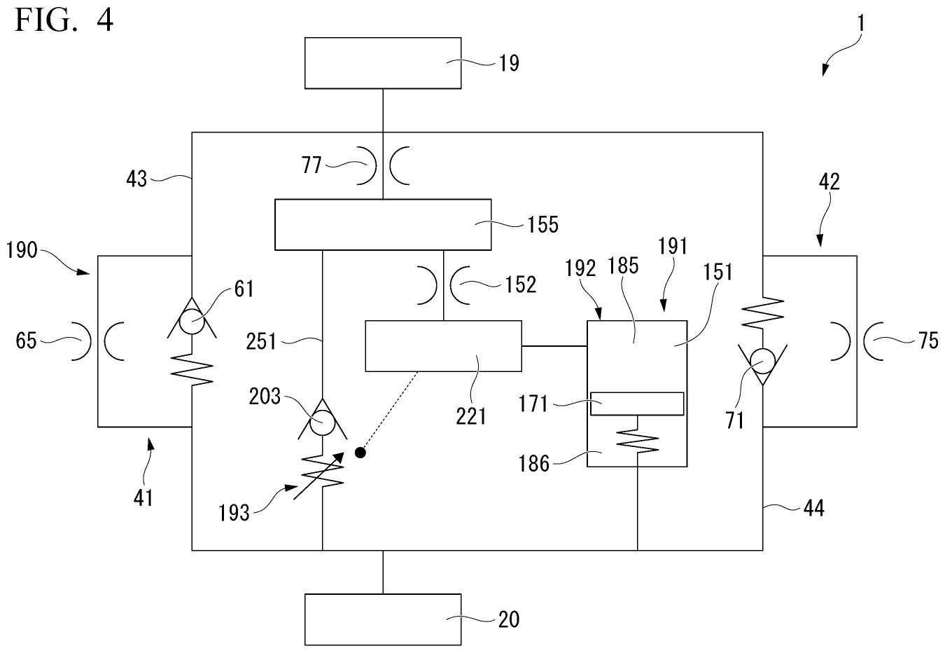

The inner seat portion 46 of the piston 18 abuts the disc 60 on the inner peripheral side which is located at the hard valve 61 on the side closest to the main body base portion 56. The valve seat portion 47 of the piston 18 abuts the outer peripheral portion of the disc 60 which is located at the hard valve 61 on the side closest to the main body base portion 56. The hard valve 61 opens and closes the piston passage 43 provided in the piston 18 by being separated from and seated in the valve seat portion 47 and generates a damping force. The hard valve 61 blocks an opening portion on the side of the lower chamber 20 which is one side of the piston passages 43. The hard valve 61 configures the damping force generation unit 41 on the extending side. The damping force generation unit 41 includes, between the hard valve 61 and the valve seat portion 47, a fixation orifice 65 which is illustrated in FIG. 4 and configures a part of the piston passage 43. The fixation orifice 65 causes the piston passage 43 to communicate with the lower chamber 20 even if the hard valve 61 and the valve seat portion 47 illustrated in FIG. 3 blocks the piston passage 43 to the maximum extent.

As illustrated in FIG. 2, a disc valve 71 including a plurality of discs 70 is provided on the side of the upper chamber 19 in the axial direction of the piston 18. One intervening disc 72 is provided on the side opposite to the piston 18 in the axial direction of the disc valve 71. An annular member 73 is provided on the side opposite to the disc valve 71 in the axial direction of the intervening disc 72. All of the intervening disc 72, the annular member 73, and the plurality of discs 70 are made of metal. The intervening disc 72, the annular member 73, and the plurality of discs 70 have flat plate shapes with constant thicknesses and have annular shapes. All of the intervening disc 72 and the plurality of discs 70 are formed through press molding from plate materials. All of the intervening disc 72, the annular member 73, and the plurality of discs 70 allow the attachment shaft portion 28 of the piston rod 21 to be fitted on the inner peripheral side. An outer diameter of the intervening disc 72 is smaller than outer diameters of all the plurality of discs 70. An outer diameter of the annular member 73 is larger than the outer diameter of the intervening disc 72 and is smaller than the outer diameters of all the plurality of discs 70. The annular member 73 has a thicker thickness and higher rigidity than each of the discs 70 configuring the disc valve 71. The annular member 73 abuts the shaft step portion 29 of the piston rod 21. Then, a throttle 77 is formed by being surrounded by the groove portion 51 of the passage groove 30 of the piston rod 21 and the annular member 73. The throttle 77 communicates with the upper chamber 19.

The inner seat portion 48 of the piston 18 abuts the disc 70 on the inner peripheral side which is located in the disc valve 71 on the side closest to the main body base portion 56 in the axial direction. The valve seat portion 49 of the piston 18 abuts the outer peripheral portion of the disc 70 which is located in the disc valve 71 on the side closest to the main body base portion 56. The disc valve 71 opens and closes the piston passage 44 provided in the piston 18 by being separated from and seated in the valve seat portion 49 and generates a damping force. The disc valve 71 blocks an opening portion on the side of the upper chamber 19 which is one side of the piston passage 44. The disc valve 71 configures the damping force generation mechanism 42 on the contracting side. The damping force generation mechanism 42 includes, between the disc valve 71 and the valve seat portion 49, a fixation orifice 75 which is illustrated in FIG. 4 and configures a part of the piston passage 44. The fixation orifice 75 causes the piston passage 44 to communicate with the upper chamber 19 even when the disc valve 71 and the valve seat portion 49 illustrated in FIG. 3 blocks the piston passage 44 to the maximum extent. The annular member 73 comes into contact with the disc valve 71 and curbs greater deformation of the disc valve 71 than a prescribed level at the time of deformation of the disc valve 71 in the opening direction.

As illustrated in FIG. 3, a seal case 81 is provided in the intervening disc 62 on the side opposite to the hard valve 61 in the axial direction. The seal case 81 has a bottomed tubular shape and includes a lid portion 82, a tapered portion 83, and a tubular wall portion 84. The seal case 81 is made of metal and is seamlessly and integrally formed. The lid portion 82 has a flat plate shape with a constant thickness and has an annular shape. The tapered portion 83 has a tapered shape and extends from an outer peripheral edge portion of the lid portion 82 to one side of the lid portion 82 in the axial direction while increasing its diameter. The tubular wall portion 84 has a tubular shape and extends from an outer peripheral edge portion of the tapered portion 83 to the side opposite to the lid portion 82 in the axial direction of the tapered portion 83. In the seal case 81, the lid portion 82, the tapered portion 83, and the tubular wall portion 84 are seamlessly and integrally formed through press molding from one plate material. The seal case 81 allows the attachment shaft portion 28 of the piston rod 21 to be fitted to the lid portion 82 on the inner peripheral side.

In the seal case 81, the lid portion 82 abuts the intervening disc 62 on the side opposite to the hard valve 61. At that time, the seal case 81 is oriented such that the tubular wall portion 84 extends on the side opposite to the hard valve 61 from the tapered portion 83 in the axial direction of the piston rod 21. The seal case 81 has a shape including the lid portion 82, the tapered portion 83, and the tubular wall portion 84 as described above and has a thicker thickness than each of the discs 60 configuring the hard valve 61. Therefore, the seal case 81 has a higher rigidity than each of the discs 60. The seal case 81 comes into contact with the hard valve 61 and curbs larger deformation of the hard valve 61 than a prescribed level at the time of deformation of the hard valve 61 in the opening direction.

A pilot case 91 (biasing force generation member) is provided in the lid portion 82 on the side opposite to the intervening disc 62 in the axial direction of the seal case 81. The pilot case 91 has a bottomed tubular shape and includes a case bottom portion 92 (bottom portion), a case tubular portion 93, a one-side projecting portion 94, and an other-side projecting portion 95. The pilot case 91 includes, on its inner peripheral side, a large diameter hole portion 101 and a small diameter hole portion 102. The large diameter hole portion 101 has a larger diameter than the small diameter hole portion 102. The large diameter hole portion 101 is formed at one end portion of the pilot case 91 in the axial direction. The small diameter hole portion 102 is formed from an intermediate portion to the other end portion of the pilot case 91 in the axial direction.

The case bottom portion 92 has an annular shape and includes a base portion 111 and a circular plate-shaped portion 112. The base portion 111 on its inner peripheral side serves as the small diameter hole portion 102. An axial-direction groove 121 extending in the axial direction of the base portion 111 is formed in the base portion 111 on one side of the outer peripheral portion in the axial direction. The circular plate-shaped portion 112 spreads outward in the radial direction of the base portion 111 from the outer peripheral portion on the side where the axial-direction groove 121 is not formed in the axial direction of the base portion 111.

The one-side projecting portion 94 has a cylindrical shape and projects on one side from the base portion 111 in the axial direction of the base portion 111. The one-side projecting portion 94 projects in the direction opposite to the circular plate-shaped portion 112 from an end portion of the base portion 111 on the side opposite to the circular plate-shaped portion 112 in the axial direction. The one-side projecting portion 94 has a smaller outer diameter than an outer diameter of the base portion 111. The one-side projecting portion 94 on its inner peripheral side serves as parts of the large diameter hole portion 101 and the small diameter hole portion 102. A radial-direction groove 125 crossing the one-side projecting portion 94 in the radial direction of the one-side projecting portion 94 is formed at an end portion of the one-side projecting portion 94 on the side opposite to the base portion 111 in the axial direction thereof.

The other-side projecting portion 95 has a tubular shape and projecting on the other side which is opposite to the one-side projecting portion 94 in the axial direction of the base portion 111 from the base portion 111. The other-side projecting portion 95 includes a conical-shaped portion 131 and a cylindrical-shaped portion 132. The conical-shaped portion 131 is formed in the other-side projecting portion 95 on the side of the base portion 111 in the axial direction. The cylindrical-shaped portion 132 is formed in the other-side projecting portion 95 on the side opposite to the base portion 111 in the axial direction. The conical-shaped portion 131 projects from the base portion 111 while reducing its outer diameter. The cylindrical-shaped portion 132 projects in the axial direction of the conical-shaped portion 131 from an end portion of the conical-shaped portion 131 on the side of the small diameter. The maximum outer diameter of the conical-shaped portion 131 of the other-side projecting portion 95 is smaller than the outer diameter of the base portion 111. The other-side projecting portion 95 on its inner peripheral side serves as the small diameter hole portion 102.

The pilot case 91 includes a passage hole 141, and the inside of the passage hole 141 serves as an in-case passage 142. The passage hole 141 and the in-case passage 142 penetrate through the conical-shaped portion 131 of the other-side projecting portion 95 and the base portion 111 in these axial directions. Therefore, the passage hole 141 and the in-case passage 142 penetrate through the case bottom portion 92 in the axial direction of the case bottom portion 92. The passage hole 141 and the in-case passage 142 are disposed in the base portion 111 further outward than the one-side projecting portion 94 and at positions at the end portion on the side of the one-side projecting portion 94 in the radial direction of the base portion 111. The pilot case 91 allows the attachment shaft portion 28 of the piston rod 21 to be fitted to the small diameter hole portion 102 which is located on the inner peripheral side of the base portion 111 and the other-side projecting portion 95.

The case tubular portion 93 has a cylindrical shape and projects on the same side as the other-side projecting portion 95 in the axial direction of the circular plate-shaped portion 112 from an outer peripheral edge portion of the circular plate-shaped portion 112. The pilot case 91 on the side opposite to the case bottom portion 92 of the case tubular portion 93 in the axial direction serves as an opening 145. The projecting length of the case tubular portion 93 from the case bottom portion 92 is shorter than the projecting length of the other-side projecting portion 95 from the case bottom portion 92.

The pilot case 91 abuts, on its one-side projecting portion 94, the lid portion 82 of the seal case 81. At that time, a part of the base portion 111 of the pilot case 91 on the side opposite to the circular plate-shaped portion 112 in the axial direction is fitted to the inside of the tubular wall portion 84 of the seal case 81. At that time, the base portion 111 of the pilot case 91 is press-fitted into the tubular wall portion 84 of the seal case 81. Through the press-fitting, a seal accommodating chamber 151 is formed by being surrounded by the lid portion 82, the tapered portion 83, and the tubular wall portion 84 of the seal case 81 and the one-side projecting portion 94 and the base portion 111 of the pilot case 91. The seal accommodating chamber 151 has an annular shape. Also, a throttle 152 is formed by being surrounded by the lid portion 82 of the seal case 81 and the radial-direction groove 125 of the pilot case 91 through the press-fitting. Additionally, a lower chamber-side passage 153 is formed by being surrounded by the axial-direction groove 121 of the pilot case 91 and the tubular wall portion 84 of the seal case 81 through the press-fitting.

The seal accommodating chamber 151 communicates with the upper chamber 19 via the throttle 152 inside the radial-direction groove 125 of the pilot case 91, a rod chamber 155 inside the groove 52 of the piston rod 21, and the throttle 77 inside the groove portion 51 of the piston rod 21 illustrated in FIG. 2. The throttle 77, the rod chamber 155, and the throttle 152 serve as an upper chamber-side passage 161. The upper chamber-side passage 161 has one end opening in the seal accommodating chamber 151 and the other end opening in the upper chamber 19. The upper chamber-side passage 161 causes the seal accommodating chamber 151 to communicate with the upper chamber 19.

As illustrated in FIG. 3, the seal accommodating chamber 151 communicates with the lower chamber 20 via the lower chamber-side passage 153 inside the axial-direction groove 121 of the pilot case 91. The lower chamber-side passage 153 has one end opening in the seal accommodating chamber 151 and the other end opening in the lower chamber 20. The lower chamber-side passage 153 causes the seal accommodating chamber 151 to communicate with the lower chamber 20. The seal accommodating chamber 151 is provided between the lower chamber-side passage 153 and the throttle 152 of the upper chamber-side passage 161.

The seal member 171 (movable portion) is provided inside the seal accommodating chamber 151. The seal member 171 is disposed therebetween when the pilot case 91 is press-fitted into the seal case 81. Once the pilot case 91 is press-fitted into the seal case 81, the seal case 81, the pilot case 91, and the seal member 171 are assembled. The seal member 171 has an annular shape. The seal member 171 is an o ring with a circular section along a plane including the center axis thereof. The seal member 171 is an elastic member with rubber elasticity. The seal member 171 is accommodated in the seal accommodating chamber 151. The seal member 171 simultaneously comes into contact with the lid portion 82 of the seal case 81 and the base portion 111 of the pilot case 91. At that time, the seal member 171 is elastically deformed in the axial direction of the seal member 171. In other words, the seal member 171 is in contact with the lid portion 82 and the base portion 111 with a fastening margin. The seal member 171 moves in the radial direction of the seal member 171 inside the seal accommodating chamber 151. The seal member 171 is elastically deformed in the radial direction of the seal member 171 inside the seal accommodating chamber 151. At least an inner diameter of the seal member 171 can expand in the radial direction of the seal member 171 inside the seal accommodating chamber 151. At least an outer diameter of the seal member 171 can contract in the radial direction of the seal member 171 inside the seal accommodating chamber 151.

The seal member 171 includes a seal portion 181, a seal portion 182, a pressure receiving portion 183, and a pressure receiving portion 184. The seal portion 181 comes into contact with the lid portion 82 of the seal case 81 and performs sealing between itself and the lid portion 82. The seal portion 182 comes into contact with the base portion 111 of the pilot case 91 and performs sealing between itself and the base portion 111. Both the seal portions 181 and 182 are provided in the seal accommodating chamber 151. The seal portions 181 and 182 of the seal member 171 curb flowing of the oil liquid from the side of the upper chamber-side passage 161 including the throttle 152 toward the lower chamber-side passage 153. The seal portions 181 and 182 also curb flowing of the oil liquid from the side of the lower chamber-side passage 153 toward the upper chamber-side passage 161. The pressure receiving portion 183 is a part of the seal member 171 on the inner side in the radial direction. The pressure receiving portion 183 receives the pressure on the side of the upper chamber-side passage 161. The pressure receiving portion 184 is a part of the seal member 171 on the outer side in the radial direction. The pressure receiving portion 184 receives the pressure on the side of the lower chamber-side passage 153. The seal member 171 has a sealing function of sectioning the inside of the seal accommodating chamber 151 into an upper chamber communication chamber 185 and a lower chamber communication chamber 186. The upper chamber communication chamber 185 communicates with the upper chamber-side passage 161. The lower chamber communication chamber 186 communicates with the lower chamber-side passage 153. The seal member 171 has both the sealing function and a characteristic of elastic deformation. The seal member 171 serves for all of the sealing function, varying of the volume, and a spring element function. The pressure receiving portion 183 forms the upper chamber communication chamber 185. The pressure receiving portion 184 forms the lower chamber communication chamber 186. The upper chamber communication chamber 185 communicates with the in-case passage 142 inside the passage hole 141 of the pilot case 91. The seal member 171 blocks communication between the in-case passage 142 and the lower chamber-side passage 153.

The seal accommodating chamber 151 and the seal member 171 configure a frequency sensitive mechanism 191 that is sensitive to a frequency of reciprocation of the piston 18 and makes a damping force variable. The damping force generation mechanism 190 is an accumulator. As illustrated in FIG. 2, the frequency sensitive mechanism 191 is disposed on the side of the lower chamber 20 out of the upper chamber 19 and the lower chamber 20. The frequency sensitive mechanism 191 communicates with the upper chamber 19 via the upper chamber-side passage 161. The frequency sensitive mechanism 191 communicates with the lower chamber 20 via the lower chamber-side passage 153. The seal accommodating chamber 151 of the frequency sensitive mechanism 191 is formed by two members, namely the seal case 81 and the pilot case 91.

As illustrated in FIG. 3, a damping force generation unit 193 is provided on the side opposite to the piston 18 in the axial direction of the pilot case 91. The damping force generation unit 193 configures the damping force generation mechanism 190 with the damping force generation unit 41 and the frequency sensitive mechanism 191. The damping force generation mechanism 190 including the damping force generation unit 41, the frequency sensitive mechanism 191, and the damping force generation unit 193 is provided in the lower chamber 20 out of the upper chamber 19 and the lower chamber 20. As illustrated in FIG. 2, the damping force generation unit 193 communicates with the upper chamber 19 via the rod chamber 155 inside the groove portion 52 of the piston rod 21 and the throttle 77 inside the groove portion 51 of the piston rod 21.

As illustrated in FIG. 3, the damping force generation unit 193 includes a damping valve 203 (first damping force generation member), a disc 204, and a seat forming member 205. The damping valve 203 includes one damping valve main body 201 and one disc 202.

The damping valve main body 201 includes a disc 211 and a seal portion 212. The disc 211 is made of metal. The disc 211 has a flat plate shape with a constant thickness and has an annular shape. The disc 211 is formed through press molding from a plate material. The disc 211 allows the attachment shaft portion 28 of the piston rod 21 to be fitted on the inner peripheral side. The disc 211 is bendable.

The seal portion 212 is an elastic material with sealability, specifically made of rubber. The seal portion 212 is bonded to the disc 211. The seal portion 212 has an annular shape. The seal portion 212 is fixedly attached to the disc 211 on the side of the piston 18 in the axial direction of the damping valve main body 201. The seal portion 212 is fixedly bonded to the outer peripheral portion of the disc 211 in the radial direction of the damping valve main body 201. The center axis of the seal portion 212 coincides with the center axis of the disc 211. The damping valve main body 201 is a packing valve with rubber.

The damping valve main body 201 abuts the cylindrical-shaped portion 132 of the other-side projecting portion 95 of the pilot case 91 on the inner peripheral side of the disc 211. The damping valve main body 201 is disposed on the side of the opening 145 of the pilot case 91 with a bottomed tubular shape. The seal portion 212 of the damping valve main body 201 is fitted over the entire periphery of the inner peripheral surface of a case tubular portion 93 of the pilot case 91 in a slidable and liquid-tight manner. The seal portion 212 constantly seals a clearance between the damping valve main body 201 and the case tubular portion 93. The damping valve main body 201 and the pilot case 91 form a pilot chamber 221. In other words, the pilot chamber 221 is formed in the pilot case 91.

Both the discs 202 and 204 are made of metal. Both the discs 202 and 204 have flat plate shapes with constant thicknesses and have annular shapes. Both the discs 202 and 204 are formed through press molding from plate materials. An outer diameter of the disc 202 is smaller than an outer diameter of the disc 211. An outer diameter of the disc 204 is smaller than the outer diameter of the disc 202. Both the discs 202 and 204 allow the attachment shaft portion 28 of the piston rod 21 to be fitted on the inner peripheral side. The disc 202 is bendable. The disc 202 abuts, in its axial direction, the disc 211 on the side opposite to the seal portion 212. The disc 204 abuts, in its axial direction, the disc 202 on the side opposite to the damping valve main body 201.

The pilot chamber 221 applies a pressure in the direction opposite to that for the piston 18 in the axial direction of the damping valve 203 to the damping valve 203. The pilot chamber 221 communicates with the upper chamber communication chamber 185 of the seal accommodating chamber 151 via the in-case passage 142 inside the passage hole 141 of the pilot case 91. Therefore, the pilot chamber 221 communicates with the upper chamber 19 via the in-case passage 142, the upper chamber communication chamber 185, the throttle 152, and the rod chamber 155 and the throttle 77 illustrated in FIG. 2. The pressures in the pilot chamber 221 and the upper chamber communication chamber 185 are set to be substantially the same by the in-case passage 142.

The seat forming member 205 is made of metal and has an annular shape. The seat forming member 205 is seamlessly and integrally formed through sintering. As illustrated in FIG. 3, the seat forming member 205 includes a member main body portion 231, an inner seat portion 232, and a valve seat portion 233 (seat). In the seat forming member 205, the member main body portion 231, the inner seat portion 232, and the valve seat portion 233 are seamlessly and integrally formed. The seat forming member 205 includes, on its inner peripheral side, a large diameter hole portion 241 and a small diameter hole portion 242. The large diameter hole portion 241 has a larger diameter than that of the small diameter hole portion 242. The seat forming member 205 allows the attachment shaft portion 28 of the piston rod 21 to be fitted to the small diameter hole portion 242.

The member main body portion 231 has a perforated circular plate shape, and its inner peripheral side serves as parts of the small diameter hole portion 242 and the large diameter hole portion 241. The inner seat portion 232 projects on one side in the axial direction of the member main body portion 231 from the inner peripheral edge portion of the member main body portion 231. The inner seat portion 232 has an annular shape, and its inner peripheral side serves as the large diameter hole portion 241. A passage groove 245 crossing the inner seat portion 232 in the radial direction is formed in the inner seat portion 232. The valve seat portion 233 projects in the axial direction of the member main body portion 231 from the outer peripheral edge portion of the member main body portion 231. The valve seat portion 233 has an annular shape. The valve seat portion 233 projects on the same side as the inner seat portion 232 from the member main body portion 231 in the axial direction of the member main body portion 231. An outer diameter of the disc 202 is larger than an outer diameter of the valve seat portion 233. An outer diameter of the disc 204 is substantially equivalent to an outer diameter of the inner seat portion 232.

The seat forming member 205 is oriented such that the inner seat portion 232 and the valve seat portion 233 are located on the side of the damping valve 203 in the axial direction. At that time, the inner seat portion 232 abuts the disc 204, and the valve seat portion 233 abuts the disc 202 of the damping valve 203. The damping valve 203 opens and closes the valve passage 250 between the damping valve 203 itself and the seat forming member 205 by the disc 202 being separated from and seated in the valve seat portion 233 of the seat forming member 205. The valve passage 250 is formed by being surrounded by the member main body portion 231, the inner seat portion 232, and the valve seat portion 233 of the seat forming member 205, the disc 204, and the damping valve 203. The throttle 77 and the rod chamber 155 of the piston rod 21 illustrated in FIG. 2, the passage inside the passage groove 245, and the valve passage 250 configure the main passage 251. The main passage 251 establishes communication such that the oil liquid flows between the upper chamber 19 and the lower chamber 20 with movement of the piston 18. The oil liquid passes through the main passage 251 when the piston rod 21 and the piston 18 move on the extending side (the upper side in FIG. 2). The damping valve 203 opens and closes the valve passage 250 of the main passage 251 and regulates a flow of the oil liquid by being separated from and seated in the valve seat portion 233. At that time, the damping valve 203 generates a damping force. The damping valve 203 configures a damping force generation unit 193 together with the valve seat portion 233. The damping force generation unit 193 is a damping force generation unit on the extending side.

The aforementioned pilot chamber 221 causes the damping valve 203 to generate a force in a direction in which the flow path area between the damping valve 203 and the valve seat portion 233 decreases, using the pressure inside the pilot chamber 221. The damping valve 203 is a damping valve of a pilot type including the pilot chamber 221 provided on the side of the piston 18 in the axial direction. These damping valve 203 and the pilot chamber 221 configure a part of the damping force generation unit 193. In other words, the damping force generation unit 193 includes the damping valve 203 and the pilot chamber 221 and serves as a valve mechanism of a pressure control type.

The pilot case 91 has a bottomed tubular shape and causes the damping valve 203 disposed on the side of the opening 145 to generate a biasing force in the valve closing direction. The piston 18 is provided on the side of the case bottom portion 92 out of the case bottom portion 92 and the case tubular portion 93 of the pilot case 91 in the axial direction. The frequency sensitive mechanism 191 is provided between the side of the damping valve 203 and the pilot case 91 and the piston 18. The frequency sensitive mechanism 191 includes a seal member 171 movably provided therein and makes a biasing force to the damping valve 203 variable.

The male screw 31 of the attachment shaft portion 28 illustrated in FIG. 1 projects on the side opposite to the piston 18 as compared with the seat forming member 205. A nut 271 is screwed onto the male screw 31. In this manner, the annular member 73, the intervening disc 72, the disc valve 71, the piston 18, the hard valve 61, the intervening disc 62, the seal case 81, the pilot case 91, the damping valve main body 201, the discs 202 and 204, and the seat forming member 205 are sandwiched between the shaft step portion 29 and the nut 271 as illustrated in FIG. 2. At this time, each of the annular member 73, the intervening disc 72, the disc valve 71, the piston 18, the hard valve 61, the intervening disc 62, the seal case 81, the pilot case 91, the damping valve main body 201, the discs 202 and 204, and the seat forming member 205 is clamped in the axial direction at least on its inner peripheral side. In this manner, each of the center axes of the annular member 73, the intervening disc 72, the disc valve 71, the piston 18, the hard valve 61, the intervening disc 62, the seal case 81, the pilot case 91, the damping valve main body 201, the discs 202 and 204, and the seat forming member 205 is caused to coincide with the center axis of the piston rod 21. The seal member 171 inside the seal accommodating chamber 151 is in a state where the piston rod 21 passes therein in the radial direction. Here, the proximal end position of the male screw 31 illustrated in FIG. 1 overlaps with the position of the small diameter hole portion 242 of the seat forming member 205 illustrated in FIG. 3 in the axial direction although not illustrated in the drawing. In this manner, the screwing length of the nut 271 is secured while the seat forming member 205 is positioned with respect to the piston rod 21 in its radial direction. In other words, a washer function necessary for the seat forming member 205 to fasten the nut 271 is also included.

At least a part of the frequency sensitive mechanism 191 is accommodated in the recessed portion 58 of the piston 18. Specifically, the entire seal accommodating chamber 151 and the entire seal member 171 are accommodated inside the recessed portion 58. In other words, the positions of the entire seal accommodating chamber 151 and the entire seal member 171 in the axial direction of the piston rod 21 and in the radial direction of the piston rod 21 are caused to overlap the recessed portion 58. The frequency sensitive mechanism 191 is provided between the side of the pilot case 91 and the damping valve 203 and the piston 18. The frequency sensitive mechanism 191 includes the seal member 171 movably provided therein and makes a biasing force to the damping valve 203 variable. The seat forming member 205 is provided in the pilot case 91 on the side of the opening 145 and includes the valve seat portion 233 formed therein to allow the damping valve 203 to be seated.

A hydraulic circuit diagram of the peripheral part of the piston 18 in the buffer 1 with the aforementioned configuration is as illustrated in FIG. 4. As illustrated in FIG. 4, the buffer 1 is provided with the piston passage 43 connecting the upper chamber 19 to the lower chamber 20. The hard valve 61 and the fixation orifice 65 both configuring the damping force generation unit 41 are provided in the piston passage 43 in parallel. Also, the buffer 1 is provided with the piston passage 44 connecting the upper chamber 19 to the lower chamber 20. The disc valve 71 and the fixation orifice 75 both configuring the damping force generation mechanism 42 are provided in the piston passage 44 in parallel. Additionally, the buffer 1 is provided with the main passage 251 connecting the upper chamber 19 to the lower chamber 20. The main passage 251 includes the throttle 77 and the rod chamber 155. The main passage 251 is provided with the damping force generation unit 193 including the damping valve 203. Also, the throttle 152 is branched from the rod chamber 155 of the main passage 251 in the buffer 1. The main passage 251 communicates with the pilot chamber 221 and the upper chamber communication chamber 185 of the frequency sensitive mechanism 191 via the throttle 152. The pressure in the pilot chamber 221 acts on the damping valve 203. The lower chamber communication chamber 186 of the seal accommodating chamber 151 communicates with the lower chamber 20. The upper chamber communication chamber 185 and the lower chamber communication chamber 186 of the seal accommodating chamber 151 are sectioned by the seal member 171.

As illustrated in FIG. 1, the aforementioned base valve 25 is provided between the inner tube 3 and the cylinder bottom portion 12 of the outer tube 4. The base valve 25 includes a base valve member 281, a disc valve 282, a disc valve 283, and an attachment pin 284. The base valve member 281 sections the lower chamber 20 and the reservoir chamber 6. The disc valve 282 is provided below the base valve member 281, that is, on the side of the reservoir chamber 6. The disc valve 283 is provided above the base valve member 281, that is, on the side of the lower chamber 20. The attachment pin 284 attaches the disc valve 282 and the disc valve 283 to the base valve member 281.

The base valve member 281 has an annular shape. The attachment pin 284 is inserted at the center of the base valve member 281 in the radial direction. A plurality of passage holes 285 and a plurality of passage holes 286 are formed in the base valve member 281. The plurality of passage holes 285 cause the oil liquid to be distributed between the lower chamber 20 and the reservoir chamber 6. The plurality of passage holes 286 cause the oil liquid to be distributed between the lower chamber 20 and the reservoir chamber 6. The plurality of passage holes 286 are provided further outward than the plurality of passage holes 285 in the radial direction of the base valve member 281. The disc valve 282 on the side of the reservoir chamber 6 allows a flow of the oil liquid from the lower chamber 20 to the reservoir chamber 6 via the passage holes 285. The disc valve 282 curbs a flow of the oil liquid from the reservoir chamber 6 to the lower chamber 20 via the passage hole 285. The disc valve 283 allows a flow of the oil liquid from the reservoir chamber 6 to the lower chamber 20 via the passage holes 286. The disc valve 283 curbs a flow of the oil liquid from the lower chamber 20 to the reservoir chamber 6 via the passage holes 286.

The disc valve 282 configures a damping force generation mechanism 287 together with the base valve member 281. The damping force generation mechanism 287 opens the valve in the contracting process of the buffer 1 and causes the oil liquid to flow from the lower chamber 20 to the reservoir chamber 6. At that time, the damping force generation mechanism 287 generates a damping force. The damping force generation mechanism 287 is a damping force generation mechanism on the contracting side. The disc valve 283 configures a suction valve 288 together with the base valve member 281. The suction valve 288 opens the valve in the extending process of the buffer 1 and causes the oil liquid to flow from the reservoir chamber 6 to the lower chamber 20. Note that the suction valve 288 causes the oil liquid to flow from the reservoir chamber 6 to the lower chamber 20 mainly to supplement shortage of liquid caused by the extension of the piston rod 21 from the cylinder 2. At that time, the suction valve 288 performs the function of causing the oil liquid to flow substantially without generating a damping force.

Next, actuation of the buffer 1 will be described. Hereinafter, a moving speed of the piston 18 will be referred to as a piston speed. Also, the frequency of reciprocation of the piston 18 will be referred to as a piston frequency below.

It is assumed that there is no frequency sensitive mechanism 191 in the buffer 1 in the extending process in which the piston rod 21 moves to the extending side. Then, the oil liquid from the upper chamber 19 illustrated in FIG. 2 does not open the damping valve 203 of the main passage 251 and flows to the lower chamber 20 via the piston passage 43 in a slightly low-speed range where the piston speed is slightly lower than a first predetermined value. At this time, the oil liquid from the upper chamber 19 is narrowed down by the fixation orifice 65 illustrated in FIG. 4 and flows to the lower chamber 20. In this manner, a damping force with an orifice characteristic is generated in the buffer 1. The orifice characteristic is a characteristic that the damping force is substantially proportional to a square of the piston speed. At this time, the characteristic of the damping force with respect to the piston speed is a hard characteristic that the increase rate of the damping force is relatively high with respect to an increase in piston speed.

Once the piston speed reaches a low-speed range that is equal to or greater than the first predetermined value, the oil liquid from the upper chamber 19 illustrated in FIG. 2 flows to the lower chamber 20 via the main passage 251 while opening the damping valve 203. Then, a damping force with a valve characteristic is generated in the buffer 1. The valve characteristic is a characteristic that the damping force is substantially proportional to the piston speed. In the low-speed range, the increase rate of the damping force with respect to an increase in piston speed is lower than the increase rate in the slightly low speed range. In the low speed range, the damping force has a softer characteristic than that in the slightly low-speed range.

Once the piston speed reaches a middle-speed range that is equal to or greater than a second predetermined value that is greater than the first predetermined value, the oil liquid from the upper chamber 19 flows to the lower chamber 20 through the piston passage 43 while opening the hard valve 61 of the damping force generation unit 41 in addition to the flow to the lower chamber 20 via the main passage 251 while opening the damping valve 203. In this manner, an increase in damping force is curbed as compared with that in the low-speed range. Therefore, the increase rate of the damping force with respect to an increase in piston speed is lower in the middle-speed range than that in the low-speed range. In the middle-speed range, the damping force has a softer characteristic than that in the low-speed range.

Once the piston speed reaches a high-speed range that is equal to or greater than a third predetermined value that is greater than the second predetermined value, a force in the opening direction applied from the valve passage 250 is greater than a force in the closing direction applied from the pilot chamber 221 in the relationship of the forces acting on the damping valve 203. Therefore, the damping valve 203 opens with a greater separation from the valve seat portion 233 of the seat forming member 205 with an increase in piston speed in this range than in the middle-speed range. Then, the oil liquid further opens the damping valve 203 as compared with the middle-speed range and flows to the lower chamber 20 via the main passage 251 in addition to the flow of the oil liquid to the lower chamber 20 through the piston passage 43 while opening the hard valve 61 as described above. Therefore, an increase in damping force is further curbed. Therefore, in the high-speed range, the increase rate of the damping force with respect to an increase in piston speed decreases as compared with the middle-speed range. In the high-speed range, the damping force has a softer characteristic than that in the middle-speed range.

In the contracting process in which the piston rod 21 moves to the contracting side, the oil liquid from the lower chamber 20 flows to the upper chamber 19 via the piston passage 44 without opening the disc valve 71 in the slightly low-speed range in which the piston speed is lower than a fourth predetermined value. At this time, the oil liquid from the lower chamber 20 is narrowed down by the fixation orifice 75 illustrated in FIG. 4 and flows to the upper chamber 19. In this manner, a damping force with an orifice characteristic is generated in the buffer 1. At this time, the characteristic of the damping force with respect to the piston speed is a hard characteristic due to a relative increase in increase rate of the damping force with respect to an increase in piston speed.

Also, once the piston speed becomes higher than the fourth predetermined value, the oil liquid from the lower chamber 20 illustrated in FIG. 2 opens the disc valve 71 and flows to the upper chamber 19 via the piston passage 44. In this manner, a damping force with a valve characteristic is generated in the buffer 1. Therefore, as for the characteristic of the damping force with respect to the piston speed, the increase rate of the damping force with respect to an increase in piston speed decreases as compared with the slightly low-speed range. Therefore, the damping force has a softer characteristic at this time than in the slightly low-speed range.

The actuation of the buffer 1 on the assumption that there is no frequency sensitive mechanism 191 has been described hitherto. On the contrary, the frequency sensitive mechanism 191 makes the damping force variable in accordance with the piston frequency even in a case of the same piston speed in the first embodiment.

When the piston frequency is high, the amplitude of the piston 18 is small. In this manner, once the pressure in the upper chamber 19 increases in the extending process when the piston frequency is high, the oil liquid from the upper chamber 19 is introduced from the upper chamber-side passage 161 to the upper chamber communication chamber 185 of the seal accommodating chamber 151. Then, in accordance with this, the pressure receiving portion 183 receives the pressure of the oil liquid on the side of the upper chamber-side passage 161 with the seal member 171 provided in the seal accommodating chamber 151 blocking the communication between the upper chamber-side passage 161 and the lower chamber-side passage 153 with the seal portions 181 and 182 illustrated in FIG. 3. In this manner, the seal member 171 is deformed while moving in the direction in which the inner diameter is expanded inside the seal accommodating chamber 151. At that time, the seal member 171 causes the oil liquid in the lower chamber communication chamber 186 of the seal accommodating chamber 151 to be discharged from the lower chamber-side passage 153 to the lower chamber 20. In other words, the seal member 171 moves and is deformed to be located closer to the side of the lower chamber 20 of the seal accommodating chamber 151 and expands the volume of the upper chamber communication chamber 185. Note that at this time, the seal member 171 blocks communication between the upper chamber-side passage 161 and the lower chamber-side passage 153. Therefore, the oil liquid is not discharged from the upper chamber-side passage 161 to the lower chamber 20.

When the piston frequency is high, oil liquid is introduced from the upper chamber 19 to the upper chamber communication chamber 185, the volume of which is expanded by the seal member 171 moving and being deformed in this manner every time the extending process is performed. As a result, the flow amount of the oil liquid flowing from the upper chamber 19 to the lower chamber 20 via the main passage 251 while opening the damping force generation unit 193 decreases. Additionally, an increase in pressure in the pilot chamber 221 is curbed as compared with a case where there is no upper chamber communication chamber 185, and the damping valve 203 of the damping force generation unit 193 is likely to be deformed in the valve opening direction, by introducing the oil liquid from the upper chamber 19 to the upper chamber communication chamber 185. In this manner, the damping force on the extending side when the piston frequency is high becomes soft. At this time, the damping force generation unit 41 including the hard valve 61 does not open the valve.

On the other hand, the amplitude of the piston 18 is large when the piston frequency is low. In this manner, the frequency of deformation of the seal member 171 also decreases with conformity in the extending process when the piston frequency is low. Then, more oil liquid is introduced from the upper chamber-side passage 161 to the upper chamber communication chamber 185 of the seal accommodating chamber 151 in an initial stage of the extending process than when the piston frequency is high. Then, the seal member 171 is greatly deformed to be located closer to the side of the lower chamber 20 inside the seal accommodating chamber 151. Then, the seal member 171 comes into contact with the tubular wall portion 84 of the seal case 81 and is compressed and deformed on the side of the tubular wall portion 84, and movement and deformation thereof are restricted by the tubular wall portion 84. Then, the oil liquid does not flow from the upper chamber 19 to the upper chamber communication chamber 185. Note that the seal member 171 blocks the communication between the upper chamber-side passage 161 and the lower chamber-side passage 153 at this time as well. Therefore, the oil liquid is not discharged from the upper chamber-side passage 161 to the lower chamber 20. Once the flowing of the oil liquid from the upper chamber 19 to the upper chamber communication chamber 185 is stopped, the pressure in the upper chamber communication chamber 185 increases, the pressure in the pilot chamber 221 communicating with the upper chamber communication chamber 185 also increases, and a state where opening of the damping valve 203 of the damping force generation unit 193 is curbed is achieved. In other words, the damping force generation unit 193 is brought into a state where it causes the oil liquid to flow from the upper chamber 19 to the lower chamber 20 via the fixation orifice 65 without the damping valve 203 opening. Therefore, the damping force on the extending side when the piston frequency is low is harder than the damping force on the extending side when the piston frequency is high.

If the pressure in the upper chamber 19 further increases when the piston frequency is low, the oil liquid in the upper chamber 19 opens the hard valve 61 of the damping force generation unit 41. Then, the oil liquid from the upper chamber 19 passes through the piston passage 43 including the clearance between the hard valve 61 and the valve seat portion 47 and flows to the lower chamber 20. If the pressure in the upper chamber 19 further increases, the oil liquid opens the damping valve 203 of the damping force generation unit 193 and flows from the valve passage 250 of the main passage 251 to the lower chamber 20 in addition to the flow through the piston passage 43.

Also, if the pressure in the lower chamber 20 increases in the contracting process when the piston frequency is high, the oil liquid is introduced from the lower chamber 20 to the lower chamber communication chamber 186 of the seal accommodating chamber 151 via the lower chamber-side passage 153. Then, the seal member 171 provided in the seal accommodating chamber 151 receives the pressure of the oil liquid in the lower chamber-side passage 153 by the pressure receiving portion 184 while blocking the communication between the lower chamber-side passage 153 and the upper chamber-side passage 161 with the seal portions 181 and 182. In this manner, the seal member 171 is deformed while moving in the direction in which the outer diameter is reduced. At that time, the seal member 171 causes the oil liquid in the upper chamber communication chamber 185 of the seal accommodating chamber 151 to be discharged to the upper chamber 19 via the upper chamber-side passage 161 including the throttle 152. In other words, the seal member 171 moves and is deformed to be located closer to the side of the upper chamber 19 of the seal accommodating chamber 151. Note that the seal member 171 blocks the communication between the lower chamber-side passage 153 and the upper chamber-side passage 161 at this time as well. Therefore, the oil liquid is not introduced from the lower chamber 20 to the upper chamber-side passage 161.

When the piston frequency is high, the oil liquid is introduced from the lower chamber 20 to the lower chamber communication chamber 186 by the seal member 171 moving and being deformed in this manner every time the contracting process is performed. As a result, the flow amount of the oil liquid flowing from the lower chamber 20 to the upper chamber 19 via the piston passage 44 while opening the disc valve 71 of the damping force generation mechanism 42 decreases. In this manner, the damping force on the contracting side when the piston frequency is high becomes soft.

On the other hand, the frequency of deformation of the seal member 171 also decreases with conformity in the contracting process when the piston frequency is low. Then, more oil liquid flows to the lower chamber communication chamber 186 via the lower chamber-side passage 153 in an initial stage of the contracting process than when the piston frequency is high, and the seal member 171 is greatly deformed. In this manner, the seal member 171 comes into contact with the one-side projecting portion 94 of the pilot case 91 and is compressed and deformed on the side of the one-side projecting portion 94, and movement and deformation thereof are restricted by the one-side projecting portion 94. Then, the flowing of the oil liquid from the lower chamber 20 to the lower chamber communication chamber 186 is stopped. The seal member 171 blocks the communication between the lower chamber-side passage 153 and the upper chamber-side passage 161 at this time as well. Therefore, the oil liquid is not introduced from the lower chamber 20 to the upper chamber-side passage 161. If the flowing of the oil liquid from the lower chamber 20 to the lower chamber communication chamber 186 is stopped, a state where the flow amount of the oil liquid flowing to the upper chamber 19 via the piston passage 44 while opening the disc valve 71 of the damping force generation mechanism 42 does not decrease is achieved. In this manner, the damping force on the contracting side when the piston frequency is low becomes harder than the damping force on the contracting side when the piston frequency is high.

Patent Literatures 1 and 2 described above do not describe a buffer including a damping force generation mechanism that is sensitive to a frequency and makes a damping force variable. Such a damping force generation mechanism is required to have a reduced size and an improved degree of freedom in designing a damping force.

The damping force generation mechanism 190 according to the first embodiment includes the pilot case 91 that causes the damping valve 203 having a bottomed tubular shape and disposed on the side of the opening 145 to generate a biasing force in the valve closing direction. Also, the damping force generation mechanism 190 includes the piston 18 provided in the pilot case 91 on the side of the case bottom portion 92 and includes the piston passage 43 formed to establish communication between the upper chamber 19 and the lower chamber 20. Moreover, the damping force generation mechanism 190 includes the frequency sensitive mechanism 191 provided between the side of the damping valve 203 and the pilot case 91 and the piston 18, includes the seal member 171 movably provided therein, and makes a biasing force in the valve closing direction to the damping valve 203 variable. In addition, the damping force generation mechanism 190 includes the seat forming member 205 provided in the pilot case 91 on the side of the opening 145 and includes the valve seat portion 233 where the damping valve 203 is seated formed therein. In this manner, the damping force generation mechanism 190 includes the piston 18 provided on the side of the case bottom portion 92 of the pilot case 91 with the bottomed tubular shape while including the damping valve 203 and the seat forming member 205 disposed in the pilot case 91 on the side of the opening 145. Therefore, the damping force generation mechanism 190 can secure the outer diameter of the damping valve 203 and causes the pilot case 91 and the piston 18 to approach each other in the axial direction without causing interference therebetween. Additionally, the damping force generation mechanism 190 includes the frequency sensitive mechanism 191 provided between the side of the damping valve 203 and the pilot case 91 and the piston 18. Therefore, the damping force generation mechanism 190 can cause the pilot case 91 and the piston 18 including the frequency sensitive mechanism 191 to approach each other in the axial direction without causing interference therebetween. Therefore, size reduction of the damping force generation mechanism 190 is possible.

In the damping force generation mechanism 190, the seat forming member 205 including the valve seat portion 233 formed therein to allow the damping valve 203 to be seated therein is provided separately from the pilot case 91. Therefore, the damping force generation mechanism 190 can tune the pressure receiving area portion of the damping valve 203 and the seat diameter of the valve seat portion 233 by changing the shape of the seat forming member 205. Accordingly, the damping force generation mechanism 190 can more easily tune the pressure receiving area portion of the damping valve 203 and the seat diameter of the valve seat portion 233 as compared with a case where the valve seat portion in which the damping valve is seated is provided in the piston. Also, the damping force generation mechanism 190 can improve a degree of freedom in the shape of the piston as compared with a case where the valve seat portion that allows the damping valve to be seated therein is provided in the piston.

The damping force generation mechanism 190 can reduce the number of components since the pilot case 91 is shared by the frequency sensitive mechanism 191 and the damping force generation unit 193.

The damping force generation mechanism 190 includes the recessed portion 58 with a smaller dimension in the axial direction within a predetermined range on the inner side of the piston 18 in the radial direction than in the other ranges. Also, at least a part of the frequency sensitive mechanism 191 is accommodated in the recessed portion 58 in the damping force generation mechanism 190. Therefore, further size reduction of the damping force generation mechanism 190 is possible. Furthermore, the damping force generation mechanism 190 can secure the length of the part of the piston 18 in contact with the inner tube 3 in the axial direction even after such size reduction. Therefore, the damping force generation mechanism 190 can stabilize movement of the piston 18 with respect to the inner tube 3.

### Second Embodiment

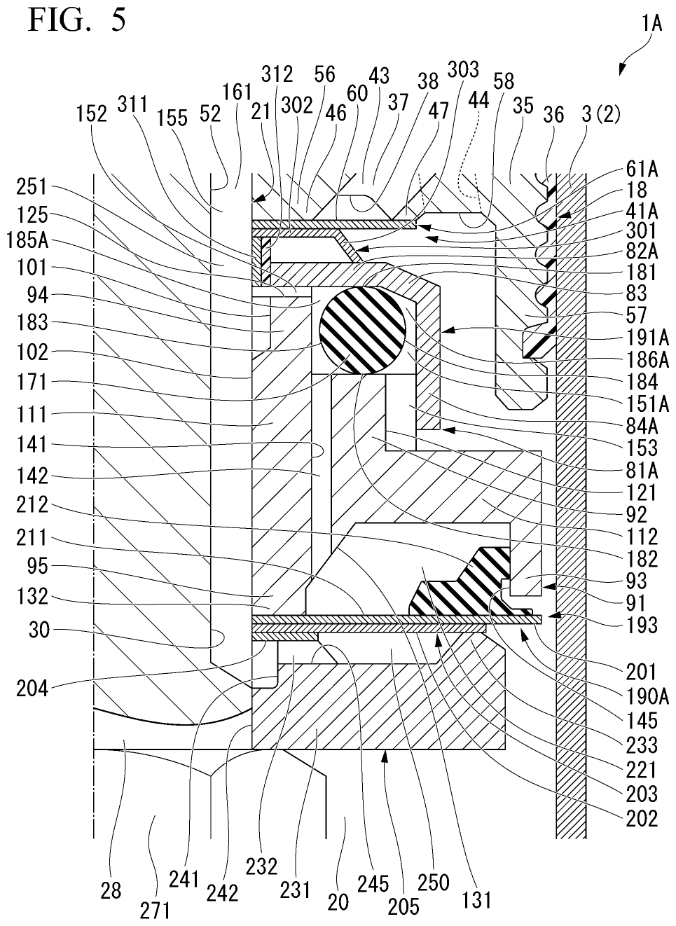

A buffer including a damping force generation mechanism according to a second embodiment of the present invention will be described by focusing on parts different from the first embodiment mainly on the basis of FIG. 5. Note that sites that are common to those in the first embodiment will be denoted by the same names and the same reference signs.

As illustrated in FIG. 5, in a buffer 1A including a damping force generation mechanism 190A according to the second embodiment, the damping force generation mechanism 190A includes a damping force generation unit 41A that is partially different from the damping force generation unit 41 instead of the damping force generation unit 41. The damping force generation unit 41A includes a sub-valve 61A (second damping force generation member) that is partially different from the hard valve 61 instead of the hard valve 61. The sub-valve 61A includes one disc 60 and one biasing member 301 instead of the plurality of discs 60 and the intervening disc 62. The disc 60 abuts the valve seat portion 47 and blocks one of opening portions of the piston passage 43. The biasing member 301 biases the disc 60 in a direction of abutting the valve seat portion 47. The biasing member 301 includes a circular plate-shaped portion 302 and an extending portion 303. The circular plate-shaped portion 302 has a perforated circular plate shape and allows an attachment shaft portion 28 of the piston rod 21 to be fitted on its inner peripheral side. The extending portion 303 extends on the side opposite to the disc 60 in the axial direction of the circular plate-shaped portion 302 from an outer peripheral edge portion of the circular plate-shaped portion 302 while expanding the diameter.

The damping force generation mechanism 190A includes a support pipe 311 and a seal ring 312. The support pipe 311 is made of metal and has a cylindrical shape. The support pipe 311 is disposed between the circular plate-shaped portion 302 of the biasing member 301 and the one-side projecting portion 94 of the pilot case 91. The support pipe 311 allows the attachment shaft portion 28 of the piston rod 21 to be fitted on its inner peripheral side. The seal ring 312 is made of a synthetic resin and has a cylindrical shape. The seal ring 312 is disposed between the circular plate-shaped portion 302 of the biasing member 301 and the one-side projecting portion 94 of the pilot case 91. The seal ring 312 allows the support pipe 311 to be fitted on its inner peripheral side.

The damping force generation mechanism 190A includes a seal case 81A that is partially different from the seal case 81 instead of the seal case 81. The seal case 81A includes a lid portion 82A with a larger inner diameter than the lid portion 82 instead of the lid portion 82. Also, the seal case 81A includes a tubular wall portion 84A with a slightly larger inner diameter than the tubular wall portion 84 instead of the tubular wall portion 84. The seal case 81A allows the seal ring 312 to be fitted on the inner peripheral side of the lid portion 82A. The seal case 81A is slidable in its axial direction with respect to the seal ring 312. In addition to this, the seal case 81A is also slidable with respect to the base portion 111 of the pilot case 91 in its axial direction. The seal ring 312 allows the seal case 81A to be movable in the axial direction while sealing a clearance between the seal ring 312 itself and the lid portion 82A of the seal case 81A.

Therefore, the damping force generation mechanism 190A includes a seal accommodating chamber 151A that is partially different from the seal accommodating chamber 151 instead of the seal accommodating chamber 151. The seal accommodating chamber 151A is stretchable in the axial direction of the pilot case 91. Therefore, the seal accommodating chamber 151A includes an upper chamber communication chamber 185A that is partially different from the upper chamber communication chamber 185 instead of the upper chamber communication chamber 185. Also, the seal accommodating chamber 151A includes a lower chamber communication chamber 186A that is partially different from the lower chamber communication chamber 186 instead of the lower chamber communication chamber 186. The upper chamber communication chamber 185A communicates with an upper chamber-side passage 161. The lower chamber communication chamber 186A communicates with the lower chamber-side passage 153. The upper chamber communication chamber 185A and the lower chamber communication chamber 186A are also stretchable in the axial direction of the pilot case 91. The damping force generation mechanism 190A includes a frequency sensitive mechanism 191A that is different from the frequency sensitive mechanism 191 in these points instead of the frequency sensitive mechanism 191. The seal accommodating chamber 151A and the seal member 171 are also accommodated inside the recessed portion 58 of the piston 18 in the frequency sensitive mechanism 191A.

Although the damping force generation mechanism 190A according to such a second embodiment is actuated in a manner substantially similar to the damping force generation mechanism 190, the following actuation is different from that of the damping force generation mechanism 190. If the pressure in the upper chamber communication chamber 185A of the seal accommodating chamber 151A increases, a pressure inside a pilot chamber 221 increases. Then, the seal case 81A moves toward the disc 60 in its axial direction and increases a biasing force of the biasing member 301 on the disc 60. In other words, the pilot case 91 applies a biasing force in the valve closing direction to the damping valve 203 and also applies a biasing force in the valve closing direction to the sub-valve 61A as well. If the pressure in the upper chamber communication chamber 185A increases at this time, the seal member 171 abuts the tapered portion 83 and the base portion 111 of the pilot case 91 even if the seal case 81A moves toward the hard valve 61 since the diameter is expanded outward in the radial direction. In this manner, the seal member 171 maintains a sealed state achieved by the seal portions 181 and 182.

The damping force generation mechanism 190A according to the second embodiment includes the sub-valve 61A that abuts the valve seat portion 47 and blocks one of opening portions of the piston passage 43 and causes the sub-valve 61A to generate a biasing force in the valve closing direction. Therefore, the damping force generation mechanism 190A can apply a biasing force in the valve closing direction to the sub-valve 61A in addition to the biasing force in the valve closing direction applied to the damping valve 203 by the pilot chamber 221. Therefore, the damping force generation mechanism 190A can increase the damping force when the pressure in the pilot chamber 221 has increased.

### Third Embodiment

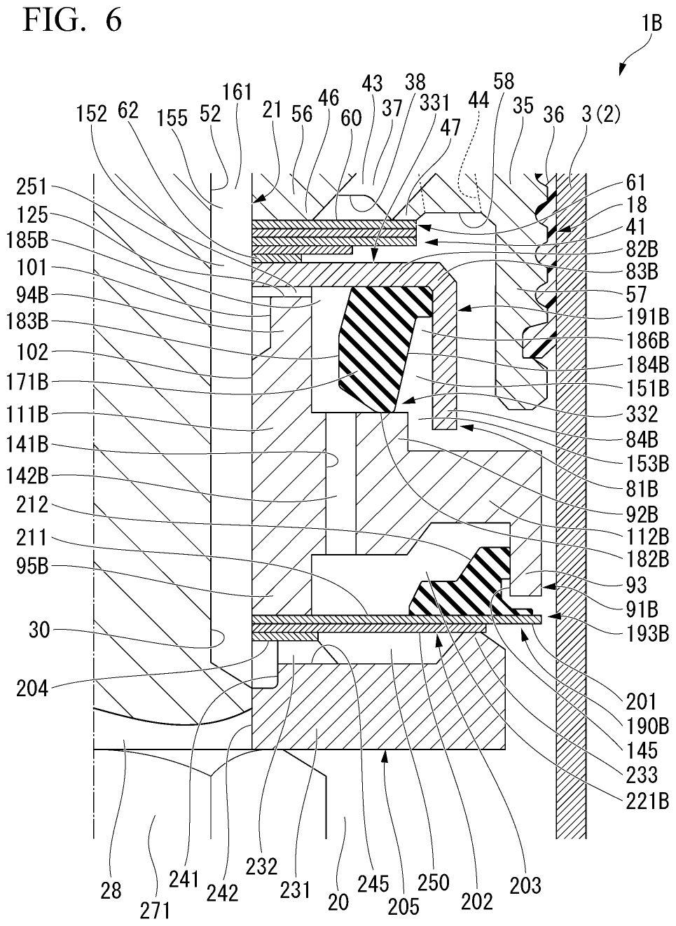

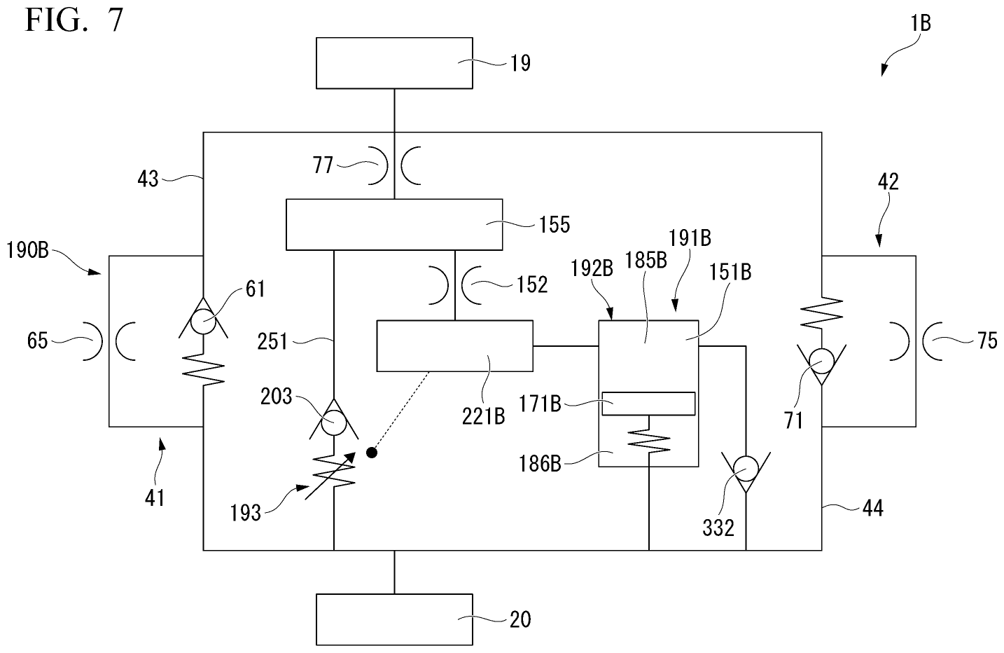

A buffer including a damping force generation mechanism according to a third embodiment of the present invention will be described by focusing on differences from the first embodiments mainly on the basis of FIGS. 6 and 7. Note that sites common to those in the first embodiment will be denoted by the same names and the same reference signs.

As illustrated in FIG. 6, in a buffer 1B including a damping force generation mechanism 190B according to the third embodiment, the damping force generation mechanism 190B includes a seal member 331 (movable portion) instead of the seal case 81 and the seal member 171. The seal member 331 includes a seal case portion 81B that is partially different from the seal case 81, and a seal main body portion 171B. The seal case portion 81B includes a lid portion 82B with a larger outer diameter than the lid portion 82 instead of the lid portion 82. Also, the seal case portion 81B includes a tapered portion 83B with shorter lengths in the radial direction of the lid portion 82B and in the axial direction of the lid portion 82B than the tapered portion 83 instead of the tapered portion 83. Additionally, the seal case portion 81B includes a tubular wall portion 84B with a longer length in the axial direction of the lid portion 82B than the tubular wall portion 84 instead of the tubular wall portion 84. The seal case portion 81B is made of metal and is seamlessly and integrally formed. The seal case portion 81B is formed through press molding from one plate material.

The seal main body portion 171B has an annular shape. The seal main body portion 171B is an elastic member with rubber elasticity. The seal main body portion 171B is bonded to the seal case portion 81B made of metal. The seal main body portion 171B extends in a tubular shape on the same side as the tubular wall portion 84 in the axial direction of the lid portion 82B from a part of the lid portion 82B on the outer side in the radial direction. The seal main body portion 171B is fixedly attached to an end surface of the lid portion 82B on the side of the tubular wall portion 84 in the axial direction, an inner peripheral surface of the tapered portion 83B, and an inner peripheral surface of the tubular wall portion 84.

The damping force generation mechanism 190B includes a pilot case 91B (biasing force generation member) that is partially different from the pilot case 91 instead of the pilot case 91. The pilot case 91B includes a case bottom portion 92B (bottom portion) that is partially different from the case bottom portion 92 instead of the case bottom portion 92. The pilot case 91B includes a one-side projecting portion 94B that is partially different from the one-side projecting portion 94 instead of the one-side projecting portion 94. The pilot case 91B includes an other-side projecting portion 95B that is partially different from the other-side projecting portion 95 instead of the other-side projecting portion 95.

The case bottom portion 92B includes a base portion 111B that is partially different from the base portion 111 instead of the base portion 111. The case bottom portion 92B includes a circular plate-shaped portion 112B that is partially different from the circular plate-shaped portion 112 instead of the circular plate-shaped portion 112. The circular plate-shaped portion 112B expands outward in the radial direction of the base portion 111B from an intermediate part of the base portion 111B in the axial direction. The length of the one-side projecting portion 94B in the axial direction is longer than that of the one-side projecting portion 94. The other-side projecting portion 95B has a cylindrical shape and has a longer length in the axial direction than the other-side projecting portion 95. The pilot case 91B has a passage hole 141B instead of the passage hole 141. The passage hole 141B penetrates through the base portion 111B in the axial direction of the base portion 111B. The inside of the passage hole 141B serves as an in-case passage 142B.

The lid portion 82B of the seal case portion 81B of the seal member 331 abuts the one-side projecting portion 94B of the pilot case 91B. At that time, the tubular wall portion 84B of the seal member 331 is separated outward in the radial direction of the base portion 111B with respect to the base portion 111B of the pilot case 91B. At that time, the seal main body portion 171B of the seal member 331 establishes abutment further outward than the passage hole 141B in the radial direction of the base portion 111B. A seal accommodating chamber 151B is formed by being surrounded by the lid portion 82B, the tapered portion 83B, and the tubular wall portion 84B of the seal case portion 81B and the one-side projecting portion 94B and the base portion 111B of the pilot case 91B. The seal accommodating chamber 151B has an annular shape. A part between the base portion 111B of the pilot case 91B and the tubular wall portion 84B of the seal case portion 81B serves as a lower chamber-side passage 153B.

The seal accommodating chamber 151B communicates with an upper chamber 19 (see FIG. 2) via an upper chamber-side passage 161 including the throttle 152 inside the radial-direction groove 125 of the pilot case 91B. The seal accommodating chamber 151B communicates with the lower chamber 20 via a lower chamber-side passage 153B between the pilot case 91 and the seal case portion 81B. The seal main body portion 171B of the seal member 331 is accommodated inside the seal accommodating chamber 151B. The seal main body portion 171B is fixed to the seal case portion 81B on the side of the seal case portion 81B. The seal main body portion 171B moves in the radial direction while being deformed in the radial direction with the site fixed to the seal case portion 81B used as a reference. The seal main body portion 171B comes into contact with the base portion 111B of the pilot case 91B. At that time, the seal main body portion 171B is elastically deformed in the axial direction of the seal main body portion 171B. In other words, the seal main body portion 171B is in contact with the base portion 111B of the pilot case 91B with a fastening margin. The seal main body portion 171B is elastically deformed in the radial direction of the seal main body portion 171B. At least an inner diameter of the seal main body portion 171B can expand in the radial direction of the seal main body portion 171B inside the seal accommodating chamber 151B. At least an outer diameter of the seal main body portion 171B can contract in the radial direction of the seal main body portion 171B inside the seal accommodating chamber 151B.

The seal main body portion 171B includes a seal portion 182B, a pressure receiving portion 183B, and a pressure receiving portion 184B. The seal portion 182B comes into contact with the base portion 111B of the pilot case 91B and seals a part between the seal portion 182B itself and the base portion 111B. The seal portion 182B is also provided in the seal accommodating chamber 151B. The seal portion 182B of the seal main body portion 171B curbs flowing of an oil liquid from the side of the upper chamber-side passage 161 including the throttle 152 to a side of the lower chamber-side passage 153B. The seal portion 182B also curbs flowing of the oil liquid from the side of the lower chamber-side passage 153B toward the upper chamber-side passage 161. The pressure receiving portion 183B is a part of the seal main body portion 171B on the inner side in the radial direction. The pressure receiving portion 183B receives a pressure on the side of the upper chamber-side passage 161. The pressure receiving portion 184B is a part of the seal main body portion 171B on the outer side in the radial direction. The pressure receiving portion 184B receives a pressure on the side of the lower chamber-side passage 153B. The seal main body portion 171B sections the inside of the seal accommodating chamber 151B into an upper chamber communication chamber 185B and a lower chamber communication chamber 186B. The upper chamber communication chamber 185B communicates with the upper chamber-side passage 161. The lower chamber communication chamber 186B communicates with the lower chamber-side passage 153. The seal main body portion 171B has a sealing function of sectioning the inside of the seal accommodating chamber 151B into the upper chamber communication chamber 185B and the lower chamber communication chamber 186B. The seal main body portion 171B also has both a sealing function and an elastic deformation characteristic and performs all of the sealing function, varying a volume, and a spring element function. The pressure receiving portion 183B forms the upper chamber communication chamber 185B. The pressure receiving portion 184B forms the lower chamber communication chamber 186B. The upper chamber communication chamber 185B communicates with the in-case passage 142B inside the passage hole 141B of the pilot case 91B. The seal main body portion 171B blocks communication between the in-case passage 142B and the lower chamber-side passage 153B.

Here, the seal main body portion 171B of the seal member 331 maintains a state where it abuts the base portion 111B even when it is deformed on the side of the tubular wall portion 84B to the maximum extent. In other words, the seal main body portion 171B blocks the communication between the upper chamber communication chamber 185B and the lower chamber communication chamber 186B even when it is deformed on the side of the tubular wall portion 84B to the maximum extent. Once the seal main body portion 171B moves by a predetermined amount on the side of the one-side projecting portion 94B, the seal main body portion 171B is separated from the base portion 111B in the axial direction of the base portion 111B. In other words, the seal main body portion 171B moves toward the one-side projecting portion 94B by a predetermined amount and then causes the upper chamber communication chamber 185B and the lower chamber communication chamber 186B to communicate with each other. Therefore, the seal member 331 and the pilot case 91B configure a check valve 332 that allows flowing of the oil liquid from the lower chamber-side passage 153B to the upper chamber-side passage 161 while blocking flowing of the oil liquid from the upper chamber-side passage 161 to the lower chamber-side passage 153B.

In the damping force generation mechanism 190B, the seal accommodating chamber 151B and the seal main body portion 171B configure a frequency sensitive mechanism 191B that is sensitive to a frequency of reciprocation of the piston 18 and makes a damping force variable. The frequency sensitive mechanism 191B is also an accumulator. The frequency sensitive mechanism 191B communicates with the upper chamber 19 via the upper chamber-side passage 161. The frequency sensitive mechanism 191B communicates with the lower chamber 20 via the lower chamber-side passage 153B. The seal accommodating chamber 151B of the frequency sensitive mechanism 191B is formed of two members, namely the pilot case 91B and the seal member 331. The seal accommodating chamber 151B and the seal main body portion 171B of the frequency sensitive mechanism 191B are also accommodated inside the recessed portion 58 of the piston 18.

A damping valve main body 201 and the pilot case 91B form a pilot chamber 221B. In other words, the pilot chamber 221B is formed in the pilot case 91B. The damping force generation unit 193B includes the damping valve 203, the disc 204, the seat forming member 205, and a pilot chamber 221B. A damping force generation unit 193B is provided on the side opposite to the piston 18 in the axial direction of the pilot case 91B. The pilot chamber 221B causes the damping valve 203 to generate a force in a direction in which the flow path area between the damping valve 203 and the valve seat portion 233 decreases, using the pressure inside the pilot chamber 221B. The pilot chamber 221B communicates with the upper chamber communication chamber 185B of the seal accommodating chamber 151B via the in-case passage 142B inside the passage hole 141B of the pilot case 91B. The pressures inside the pilot chamber 221B and the upper chamber communication chamber 185B are set to be substantially the same by the in-case passage 142B. The seal main body portion 171B of the seal member 331 has a sealing function by being in contact with the pilot case 91B with a fastening margin. The seal main body portion 171B prevents the pressure inside the pilot chamber 221B from escaping to the lower chamber 20.

The pilot case 91B causes the damping valve 203 having a bottomed tubular shape and disposed on the side of the opening 145 to generate a biasing force in the valve closing direction. The piston 18 is provided on the side of the case bottom portion 92B out of the case bottom portion 92B and the case tubular portion 93 in the axial direction of the pilot case 91B. The frequency sensitive mechanism 191B is provided between the side of the damping valve 203 and the pilot case 91B and the piston 18. The frequency sensitive mechanism 191B includes the seal main body portion 171B movably provided therein and makes a biasing force to the damping valve 203 variable.

A hydraulic circuit diagram of a peripheral part of the piston 18 in the buffer 1B with the aforementioned configuration is as illustrated in FIG. 7. As illustrated in FIG. 7, the main passage 251 of the buffer 1B communicates with the pilot chamber 221B and the upper chamber communication chamber 185B of the frequency sensitive mechanism 191B via the throttle 152. The pressure in the pilot chamber 221B acts on the damping valve 203. The lower chamber communication chamber 186B of the seal accommodating chamber 151B communicates with the lower chamber 20. The check valve 332 is provided between the upper chamber communication chamber 185 of the seal accommodating chamber 151 and the lower chamber 20.

The damping force generation mechanism 190B according to such a third embodiment is actuated substantially similarly to the damping force generation mechanism 190. In other words, the oil liquid from the upper chamber 19 is introduced from the upper chamber-side passage 161 to the upper chamber communication chamber 185B in the extending process when the piston frequency is high. Then, in accordance with this, the seal main body portion 171B receives the pressure of the oil liquid on the side of the upper chamber-side passage 161 by the pressure receiving portion 183B while blocking the communication between the upper chamber-side passage 161 and the lower chamber-side passage 153B with the seal portion 182B. In this manner, the seal main body portion 171B is deformed in a direction in which the inner diameter is expanded. When the piston frequency is high, the seal main body portion 171B is deformed in this manner to cause the oil liquid to flow from the upper chamber 19 to the upper chamber communication chamber 185B every time the extending process is performed.

On the other hand, more oil liquid is introduced from the upper chamber-side passage 161 to the upper chamber communication chamber 185B in an initial stage of the extending process in the extending process when the piston frequency is low than when the piston frequency is high. Then, the seal main body portion 171B comes into contact with the tubular wall portion 84B of the seal case portion 81B, and deformation is then restricted by the tubular wall portion 84B. The flowing of the oil liquid from the upper chamber 19 to the upper chamber communication chamber 185B is stopped by the seal main body portion 171B being deformed in this manner. Note that the seal main body portion 171B blocks the communication between the upper chamber-side passage 161 and the lower chamber-side passage 153B at this time as well. In other words, the seal main body portion 171B receives a pressure load from the inner peripheral side, maintains the sealing function at the lower end portion, and changes its shape to expand outward in the extending process.

Also, in the contracting process when the piston frequency is high, the oil liquid is introduced from the lower chamber 20 to the lower chamber communication chamber 186B via the lower chamber-side passage 153B. Then, the seal main body portion 171B receives the pressure of the oil liquid on the side of the lower chamber-side passage 153B by the pressure receiving portion 184B while blocking the communication between the lower chamber-side passage 153B and the upper chamber-side passage 161 with the seal portion 182B. In this manner, the seal main body portion 171B is deformed while moving in a direction in which the outer diameter thereof is reduced. When the piston frequency is high, the seal main body portion 171B is deformed in this manner to cause the oil liquid to flow from the lower chamber 20 to the lower chamber communication chamber 186B every time the contracting process is performed. In other words, the seal main body portion 171B is bent and deformed inward by receiving the pressure from the lower chamber 20 in the contracting process.

On the other hand, in the contracting process when the piston frequency is low, more oil liquid flows to the lower chamber communication chamber 186B via the lower chamber-side passage 153B in the initial stage of the contracting process than when the piston frequency is high, to thereby greatly deform the seal main body portion 171B. In this manner, the seal main body portion 171B comes into contact with the one-side projecting portion 94B of the pilot case 91B, and the deformation is then restricted by the one-side projecting portion 94B. Then, flowing of the oil liquid from the lower chamber 20 to the lower chamber communication chamber 186B is stopped.

In the damping force generation mechanism 190B according to the third embodiment, the frequency sensitive mechanism 191B is provided with the check valve 332. Therefore, if a pressure load is applied to some extend in the contracting process, a distal end portion of the seal main body portion 171B is separated from the pilot case 91B, and the oil liquid flows from the lower chamber 20 to the pilot chamber 221B in the damping force generation mechanism 190B. In this manner, the damping valve 203 that has been opened in the extending process performed right before receives the pressure in the pilot chamber 221B as a back pressure and is closed in the damping force generation mechanism 190B. Therefore, the damping force generation mechanism 190B can curb a closing delay of the damping valve 203.

Also, the damping force generation mechanism 190B includes the seal member 331 in which the seal case portion 81B and the seal main body portion 171B are integrated. Therefore, the damping force generation mechanism 190B can reduce the number of components. Also, it is only necessary to assemble a single component, namely the seal member 331 instead of assembling two components, namely the seal case and the seal member at the time of assembly with the piston rod 21 according to the damping force generation mechanism 190B. Therefore, the damping force generation mechanism 190B can improve an easiness of assembly.

### Fourth Embodiment

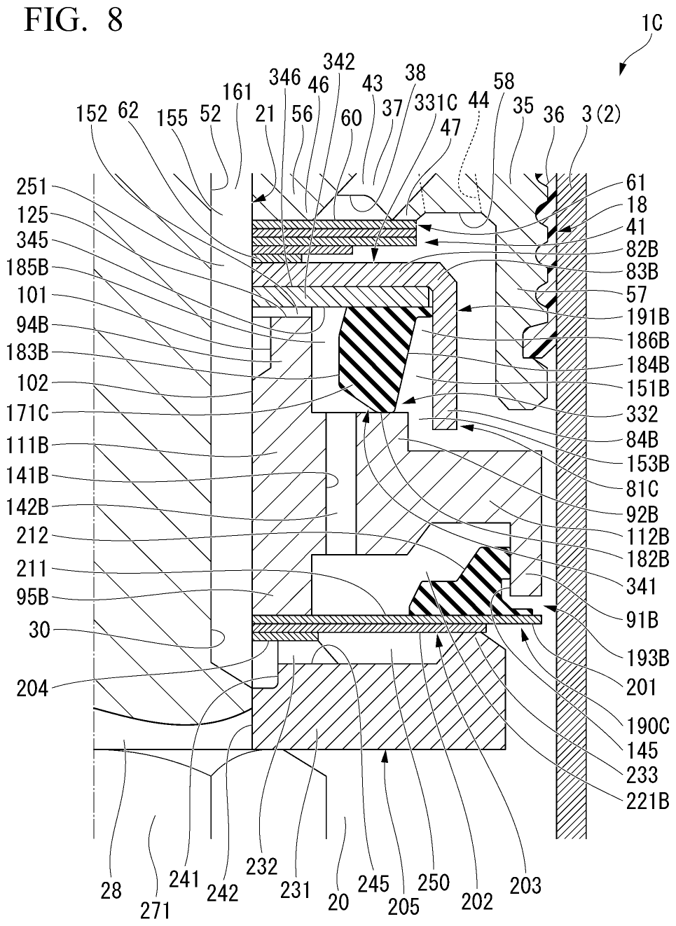

A buffer including a damping force generation mechanism according to a fourth embodiment of the present invention will be described by focusing on differences from the third embodiment mainly on the basis of FIG. 8. Note that sites that are common to those in the third embodiment will be denoted by the same names and the same reference signs.

As illustrated in FIG. 8, in a buffer 1C including a damping force generation mechanism 190C according to the fourth embodiment, the damping force generation mechanism 190C includes a seal member 331C (movable portion) that is partially different from the seal member 331 instead of the seal member 331. The seal member 331C includes a seal case 81C (seating portion) that is similar to the seal case portion 81B and a seal main body member 341 (elastic fixing member) that is an element separated from the seal case 81C. The seal main body member 341 includes a support disc 342 (fixing portion) and a seal main body portion 171C (elastic portion) that is elastically deformable substantially similarly to the seal main body portion 171B. The support disc 342 is made of metal. The support disc 342 has a flat plate shape with a constant thickness and has an annular shape. The support disc 342 is formed through press molding from a plate material. The seal main body portion 171C is attached to an outer peripheral portion of a first surface 345 of the support disc 342 on one side in the axial direction. The seal main body member 341 is seated in a lid portion 82B of the seal case 81C on a second surface 346 of the support disc 342 on the side opposite to the seal main body portion 171C in the axial direction. At that time, the support disc 342 allows the attachment shaft portion 28 of the piston rod 21 to be fitted on the inner peripheral side.

The damping force generation mechanism 190C according to the fourth embodiment is actuated similarly to the damping force generation mechanism 190B.

The seal member 331C of the damping force generation mechanism 190C includes two components, namely the seal main body member 341 and the seal case 81C that is an element separated therefrom. The elastically deformable seal main body portion 171C of the seal main body member 341 includes the support disc 342 fixed to the first surface 345. The seal case 81C is disposed between the seal main body member 341 and the piston 18, and the second surface 346 of the support disc 342 can be seated therein. In this manner, the seal member 331C of the damping force generation mechanism 190C includes two components, namely the seal main body member 341 including the seal main body portion 171C and the seal case 81C. Therefore, even in a case where the characteristic of the seal main body portion 171C is changed in the damping force generation mechanism 190C, it is only necessary to change the seal main body member 341, and there is no need to change the seal case 81C. Therefore, the damping force generation mechanism 190C can have the seal case 81C as a common component for a plurality of types of seal members 331C with different characteristics. Therefore, the damping force generation mechanism 190C can have enhanced versatility.

### Fifth Embodiment

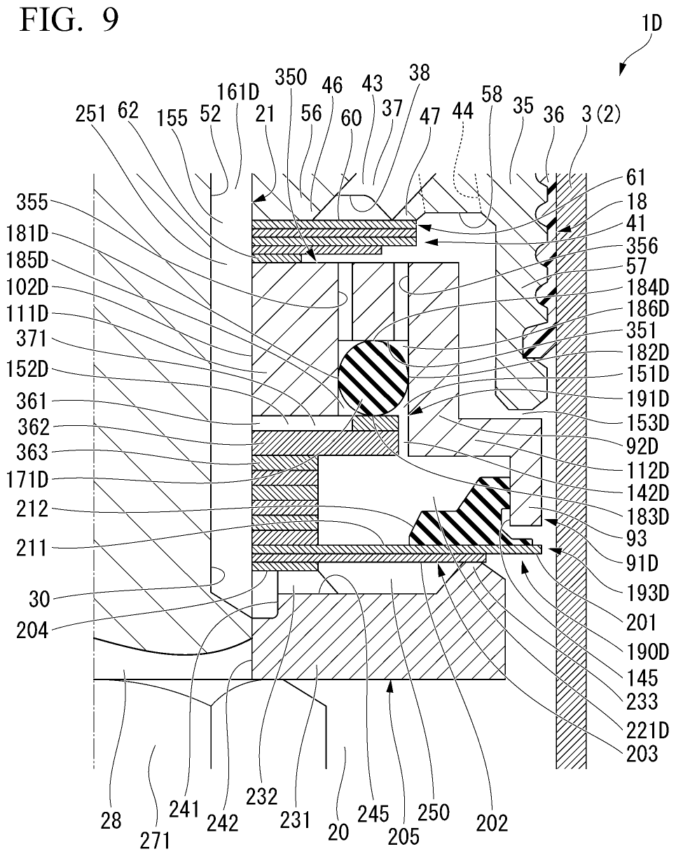

A buffer including a damping force generation mechanism according to a fifth embodiment of the present invention will be described by focusing on differences from the first embodiment mainly on the basis of FIG. 9. Note that sites that are common to those in the first embodiment will be denoted by the same names and the same reference signs.

As illustrated in FIG. 9, in a buffer 1D including a damping force generation mechanism 190D according to the fifth embodiment, the damping force generation mechanism 190D does not include the seal case 81. Also, the damping force generation mechanism 190D includes a pilot case 91D (biasing force generation member) that is partially different from the pilot case 91 instead of the pilot case 91. The pilot case 91D includes a pilot case main body 350 that is partially different from the pilot case 91, a passage forming disc 361 (support portion), a reinforcing disc 362 (support portion), and a plurality of discs 363.

The pilot case main body 350 includes a case bottom portion 92D (bottom portion) that is partially different from the case bottom portion 92 instead of the case bottom portion 92. The pilot case main body 350 is not provided with the one-side projecting portion 94 and the other-side projecting portion 95.

The case bottom portion 92D includes a base portion 111D that is partially different from the base portion 111 instead of the base portion 111. The case bottom portion 92D includes a circular plate-shaped portion 112D that is partially different from the circular plate-shaped portion 112 instead of the circular plate-shaped portion 112. The case bottom portion 92D abuts an intervening disc 62 at the base portion 111D. The circular plate-shaped portion 112D spreads outward in the radial direction of the base portion 111D from the side further outward than an end portion of the base portion 111D on the side opposite to the intervening disc 62 in the axial direction. The case tubular portion 93 extends on the side opposite to the base portion 111D in the axial direction of the circular plate-shaped portion 112D from an outer peripheral edge portion of the circular plate-shaped portion 112D. The base portion 111D on its inner peripheral side does not include the large diameter hole portion 101 and includes a hole portion 102D with a constant inner diameter that is the same as the diameter of the small diameter hole portion 102. The pilot case main body 350 allows the attachment shaft portion 28 of the piston rod 21 to be fitted to the hole portion 102D.

An accommodating recessed portion 351 (accommodating portion) is formed in the base portion 111D on the side of the case tubular portion 93 in its axial direction and on the side of the circular plate-shaped portion 112D in its radial direction. The accommodating recessed portion 351 is recessed on the side opposite to the case tubular portion 93 in the axial direction of the base portion 111D from the surface on the side of the case tubular portion 93 in the axial direction of the base portion 111D. The accommodating recessed portion 351 has an annular shape with the same axis as that of the hole portion 102D. Also, passage holes 355 and passage holes 356 penetrating through the base portion 111D in the axial direction of the base portion 111D at positions in the bottom portion of the accommodating recessed portion 351 in the base portion 111D are formed. The passage holes 355 are formed at inner end positions of the accommodating recessed portion 351 in the radial direction. The passage holes 356 are formed at outer end positions of the accommodating recessed portion 351 in the radial direction. Therefore, the passage holes 356 are located further outward than the passage holes 355 in the radial direction of the accommodating recessed portion 351. The plurality of passage holes 355 are provided in the base portion 111D at equal intervals in the circumferential direction of the accommodating recessed portion 351. The plurality of passage holes 356 are provided in the base portion 111D at equal intervals in the circumferential direction of the accommodating recessed portion 351. Note that although both the passage holes 355 and the passage holes 356 are illustrated in FIG. 9, the passage holes 355 and the passage holes 356 are provided alternately in the circumferential direction of the accommodating recessed portion 351. The passage hole 141 is not formed in the base portion 111D.

All of the passage forming disc 361, the reinforcing disc 362, and the plurality of discs 363 are made of metal. All of the passage forming disc 361, the reinforcing disc 362, and the plurality of discs 363 have flat plate shapes with constant thicknesses and have annular shapes. All of the passage forming disc 361, the reinforcing disc 362, and the plurality of discs 363 are formed through press molding from plate materials. All of the passage forming disc 361, the reinforcing disc 362, and the plurality of discs 363 allow the attachment shaft portion 28 of the piston rod 21 to be fitted on the inner peripheral side.

The passage forming disc 361 includes a notch portion 371 formed to extend outward in the radial direction from its inner peripheral end edge. The passage forming disc 361 establishes abutment on the side opposite to the intervening disc 62 in the axial direction of the base portion 111D. The notch portion 371 extends up to a side further outward in the radial direction than an inner end position of the accommodating recessed portion 351 in the radial direction. The position of the passage forming disc 361 overlaps the circular plate-shaped portion 112D in the axial direction of the pilot case main body 350.

The outer diameter of the reinforcing disc 362 is the same as the outer diameter of the passage forming disc 361. The reinforcing disc 362 abuts the passage forming disc 361 on the side opposite to the base portion 111D in the axial direction. The reinforcing disc 362 covers the notch portion 371 of the passage forming disc 361 on the side opposite to the base portion 111D. The position of the reinforcing disc 362 overlaps the circular plate-shaped portion 112D in the axial direction of the pilot case main body 350.

The outer diameters of all the plurality of discs 363 are smaller than the outer diameter of the reinforcing disc 362. The plurality of discs 363 are provided between the disc 211 of the damping valve main body 201 and the reinforcing disc 362 and abut them.

A seal accommodating chamber 151D is formed by being surrounded by the passage forming disc 361, the reinforcing disc 362, and the accommodating recessed portion 351 of the pilot case main body 350. The seal accommodating chamber 151D is formed inside the accommodating recessed portion 351 and has an annular shape. The inside of the notch portion 371 of the passage forming disc 361 serves as a throttle 152D establishing communication between the rod chamber 155 and the seal accommodating chamber 151D. A part between the inside of the passage holes 355 and 356 and the side of the piston 18 and the pilot case main body 350 serves as a lower chamber-side passage 153D that establishes communication between the lower chamber 20 and the seal accommodating chamber 151D. The lower chamber-side passage 153D includes a passage between a main body tubular portion 57 of the piston 18 and the circular plate-shaped portion 112D of the pilot case main body 350.

The seal accommodating chamber 151D communicates with the upper chamber 19 (see FIG. 2) via the throttle 152D inside the notch portion 371 of the passage forming disc 361, the rod chamber 155 of the piston rod 21, and the throttle 77 (see FIG. 2) of the piston rod 21. The throttle 77, the rod chamber 155, and the throttle 152D serve as an upper chamber-side passage 161D. The upper chamber-side passage 161D has one end opening in the seal accommodating chamber 151D and the other end opening in the upper chamber 19. The upper chamber-side passage 161D causes the seal accommodating chamber 151D communicate with the upper chamber 19.

The seal accommodating chamber 151D communicates with the lower chamber 20 via the lower chamber-side passage 153D including the inside of the passage holes 355 and 356 of the pilot case main body 350. The lower chamber-side passage 153D has one end opening in the seal accommodating chamber 151D and the other end opening in the lower chamber 20. The seal accommodating chamber 151D is provided between the lower chamber-side passage 153D and the throttle 152D of the upper chamber-side passage 161D.

The damping force generation mechanism 190D is provided with a seal member 171D (movable portion) with a different size from that of the seal member 171 instead of the seal member 171. The seal member 171D is an elastic member with rubber elasticity similarly to the seal member 171. The seal member 171D is an O ring. The seal member 171D is accommodate in the seal accommodating chamber 151D. The seal member 171D comes into contact with an inner wall portion of the accommodating recessed portion 351 on the inner side in the radial direction and an outer wall portion of the accommodating recessed portion 351 on the outer side in the radial direction of the pilot case main body 350 at the same time. At that time, the seal member 171D is elastically deformed in the radial direction of the seal member 171D. In other words, the seal member 171D is in contact with the inner wall portion and the outer wall portion of the accommodating recessed portion 351 with a fastening margin. The seal member 171D moves in the axial direction of the seal member 171D inside the seal accommodating chamber 151D. The seal member 171D is elastically deformed in the axial direction of the seal member 171D inside the seal accommodating chamber 151D.

The seal member 171D includes a seal portion 181D, a seal portion 182D, a pressure receiving portion 183D, and a pressure receiving portion 184D. The seal portion 181D comes into contact with the inner wall portion of the accommodating recessed portion 351 and seals a part between the seal portion 181D itself and the inner wall portion. The seal portion 182D comes into contact with the outer wall portion of the accommodating recessed portion 351 and seals a part between the seal portion 182D itself and the outer wall portion. The seal portions 181D and 182D are also provided in the seal accommodating chamber 151D. The seal portions 181D and 182D of the seal member 171D curb flowing of an oil liquid from the side of the upper chamber-side passage 161D including the throttle 152D toward the lower chamber-side passage 153D. The seal portions 181D and 182D also curb flowing of the oil liquid from the side of the lower chamber-side passage 153D toward the upper chamber-side passage 161D. The pressure receiving portion 183D is a part of the seal member 171D on the side of the passage forming disc 361 in the axial direction. The pressure receiving portion 183D receives a pressure on the side of the upper chamber-side passage 161D. The pressure receiving portion 184D is a part of the seal member 171D on the side of the bottom portion of the accommodating recessed portion 351 in the axial direction. The pressure receiving portion 184D receives a pressure on the side of the lower chamber-side passage 153D. The seal member 171D has a sealing function of sectioning the inside of the seal accommodating chamber 151D into an upper chamber communication chamber 185D and a lower chamber communication chamber 186D. The upper chamber communication chamber 185D communicates with the upper chamber-side passage 161D. The lower chamber communication chamber 186D communicates with the lower chamber-side passage 153D. The seal member 171D has both the sealing function and an elastic deformation characteristic. The seal member 171D has all of the sealing function, varying of the volume, and a spring element function. The pressure receiving portion 183D forms the upper chamber communication chamber 185D. The pressure receiving portion 184D forms the lower chamber communication chamber 186D. A part between the circular plate-shaped portion 112D of the pilot case main body 350 and the side of the passage forming disc 361 and the reinforcing disc 362 serves as a passage 142D. The upper chamber communication chamber 185D communicates with the passage 142D. The seal member 171D blocks communication between the side of the throttle 152D and the passage 142D and the lower chamber-side passage 153D.

The seal accommodating chamber 151D and the seal member 171D of the damping force generation mechanism 190D configure a frequency sensitive mechanism 191D that is sensitive to a frequency of reciprocation of the piston 18 and makes a damping force variable. The damping force generation mechanism 190D is also an accumulator. The frequency sensitive mechanism 191D communicates with the upper chamber 19 via the upper chamber-side passage 161D. The frequency sensitive mechanism 191D communicates with the lower chamber 20 via the lower chamber-side passage 153D. The seal accommodating chamber 151D and the seal member 171D of the frequency sensitive mechanism 191D are also accommodated inside the recessed portion 58 of the piston 18.

The pilot case main body 350, the reinforcing disc 362, and the plurality of discs 363 of the pilot case 91D and the damping valve main body 201 form a pilot chamber 221D. In other words, the pilot chamber 221D is formed in the pilot case 91D. A damping force generation unit 193D includes the damping valve 203, the disc 204, the seat forming member 205, and the pilot chamber 221D. The damping force generation unit 193D is provided on the side opposite to the piston 18 in the axial direction of the pilot case 91D. The pilot chamber 221D causes the damping valve 203 to generate a force in a direction in which a flow path area between the damping valve 203 and the valve seat portion 233 decreases, using the pressure inside the pilot chamber 221D. The pilot chamber 221D communicates with the upper chamber communication chamber 185D of the seal accommodating chamber 151D via the passage 142D. Therefore, the pilot chamber 221D communicates with the upper chamber 19 (see FIG. 2) via the passage 142D, the upper chamber communication chamber 185D, and the upper chamber-side passage 161D. The pressures of the pilot chamber 221D and the upper chamber communication chamber 185D are set to be substantially the same by the passage 142D.

The pilot case 91D causes the damping valve 203 having a bottomed tubular shape and disposed on the side of the opening 145 to generate a biasing force in a valve closing direction. The piston 18 is provided on the side of the case bottom portion 92D out of the case bottom portion 92D and the case tubular portion 93 in the axial direction of the pilot case 91D. The frequency sensitive mechanism 191D is provided between the piston 18 and the damping valve 203. The frequency sensitive mechanism 191D includes the seal member 171D movably provided therein and makes a biasing force to the damping valve 203 variable.

A hydraulic circuit diagram of a peripheral part of the piston 18 in the buffer 1D with the aforementioned configuration is similar to that of the buffer 1 illustrated in FIG. 4. The damping force generation mechanism 190D is actuated substantially similarly to the damping force generation mechanism 190. In the damping force generation mechanism 190D, the oil liquid from the upper chamber 19 is introduced from the upper chamber-side passage 161D to the upper chamber communication chamber 185D in the extending process when the piston frequency is high. Then, in accordance with this, the seal member 171D receives the pressure of the oil liquid on the side of the upper chamber-side passage 161D by the pressure receiving portion 183D while blocking communication between the upper chamber-side passage 161D and the lower chamber-side passage 153D with the seal portions 181D and 182D. In this manner, the seal member 171D is deformed while moving in the direction of the bottom portion of the accommodating recessed portion 351. When the piston frequency is high, the seal member 171D moves and is deformed in this manner to cause the oil liquid to flow from the upper chamber 19 to the upper chamber communication chamber 185D every time the extending process is performed.

On the other hand, in the extending process when the piston frequency is low, more oil liquid is introduced from the upper chamber-side passage 161D to the upper chamber communication chamber 185D in an initial stage of the extending process than when the piston frequency is high. Then, the seal member 171D significantly moves and is deformed on the side of the bottom portion of the accommodating recessed portion 351 and is then brought into a state where the movement and the deformation are restricted by the bottom portion of the accommodating recessed portion 351. In this manner, the flowing of the oil liquid from the upper chamber 19 to the upper chamber communication chamber 185D is stopped. Note that the seal member 171D blocks the communication between the upper chamber-side passage 161D and the lower chamber-side passage 153D at this time as well.

Also, in the contracting process when the piston frequency is high, the oil liquid is introduced from the lower chamber 20 to the lower chamber communication chamber 186D via the lower chamber-side passage 153D. Then, the seal member 171D receives the pressure on the side of the lower chamber-side passage 153D by the pressure receiving portion 184D while blocking the communication between the lower chamber-side passage 153D and the upper chamber-side passage 161D with the seal portions 181D and 182D. In this manner, the seal member 171D is deformed while moving toward the passage forming disc 361. When the piston frequency is high, the seal member 171D moves and is deformed in this manner to cause the oil liquid to flow from the lower chamber 20 to the lower chamber communication chamber 186D every time the contracting process is performed.

On the other hand, in the contracting process when the piston frequency is low, more oil liquid flows to the lower chamber communication chamber 186D via the lower chamber-side passage 153D in an initial stage of the contracting process than when the piston frequency is high. Then, the seal member 171D significantly moves and is deformed on the side of the passage forming disc 361 and is then brought into a state where the movement and the deformation are restricted by the passage forming disc 361. In this manner, the flowing of the oil liquid from the lower chamber 20 to the lower chamber communication chamber 186D is stopped. At that time, the reinforcing disc 362 abutting the passage forming disc 361 curbs deformation of the passage forming disc 361. In other words, the passage forming disc 361 and the reinforcing disc 362 form a lid such that the seal member 171D accommodated in the seal accommodating chamber 151D does not move toward the pilot chamber 221D. The seal member 171D blocks the communication between the lower chamber-side passage 153D and the upper chamber-side passage 161D in the contracting process when the piston frequency is low as well.

In the damping force generation mechanism 190D according to the fifth embodiment, the seal member 171D is accommodated in the accommodating recessed portion 351 of the pilot case main body 350. Therefore, according to the damping force generation mechanism 190D, it is possible to fit the seal member 171D into the accommodating recessed portion 351 of the pilot case main body 350 in advance and to then assemble, with the piston rod 21, the seal member 171D together with the pilot case main body 350. Therefore, easiness of assembly of the seal member 171D in the damping force generation mechanism 190D is improved.

### Sixth Embodiment

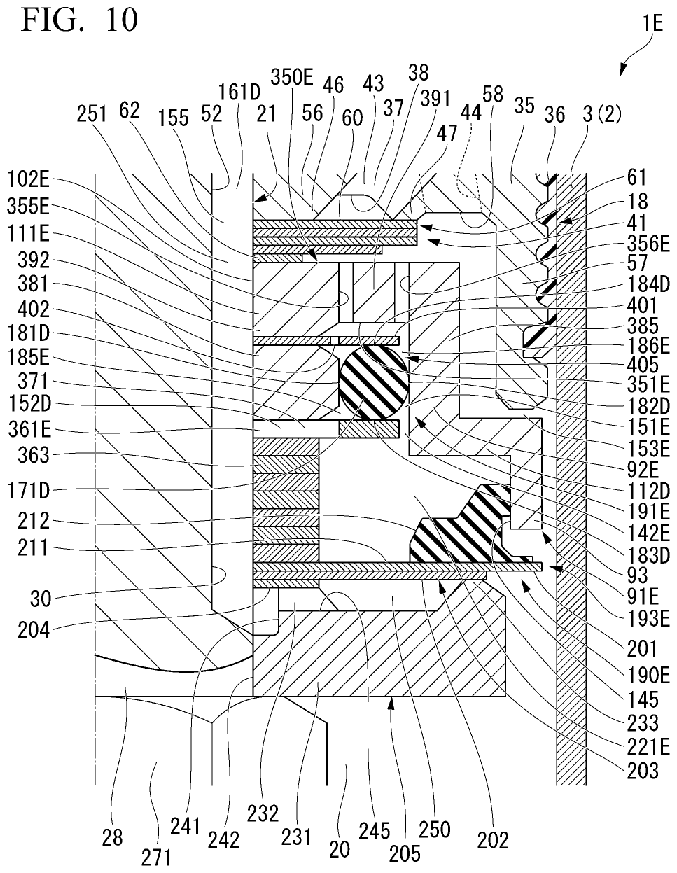

A buffer including a damping force generation mechanism according to a sixth embodiment of the present invention will be described by focusing on differences from the fifth embodiment mainly on the basis of FIG. 10. Note that sites that are common to those in the fifth embodiment will be denoted by the same names and the same reference signs.

As illustrated in FIG. 10, in a buffer 1E including a damping force generation mechanism 190E according to the sixth embodiment, the damping force generation mechanism 190E includes a pilot case 91E (biasing force generation member) that is partially different from the pilot case 91D instead of the pilot case 91D. The pilot case 91E includes a pilot case main body 350E (other-side portion) that is partially different from the pilot case main body 350 instead of the pilot case main body 350. The pilot case 91E includes an inner member 381 (one-side portion), a passage forming disc 361E (support portion), and a plurality of discs 363. The pilot case 91E is not provided with the reinforcing disc 362. However, the passage forming disc 361E has a thicker thickness and higher rigidity than the passage forming disc 361. The passage forming disc 361E forms the throttle 152D by the notch portion 371 similarly to the passage forming disc 361.

The pilot case main body 350E is made of metal and is seamlessly and integrally formed. The pilot case main body 350E includes a case bottom portion 92E (bottom portion) that is partially different from the case bottom portion 92D instead of the case bottom portion 92D. The case bottom portion 92E includes a base portion 111E that is partially different from the base portion 111D instead of the base portion 111D. The case bottom portion 92E includes a tubular portion 385 between the base portion 111E and the circular plate-shaped portion 112D. The tubular portion 385 has a cylindrical shape. The cylindrical-shaped portion 385 extends on the side opposite to the case tubular portion 93 in the axial direction of the circular plate-shaped portion 112D from an inner peripheral edge portion of the circular plate-shaped portion 112D. The base portion 111E spreads inward in the radial direction of the tubular portion 385 from an end portion on the side opposite to the circular plate-shaped portion 112D in the axial direction of the tubular portion 385. The base portion 111E on the inner peripheral side serves as a hole portion 102E with the same constant inner diameter than that of the hole portion 102D. The pilot case main body 350E allows the attachment shaft portion 28 of the piston rod 21 to be fitted into the hole portion 102E.

The base portion 111E includes a main body portion 391 and an inner projecting portion 392. The main body portion 391 has a flat plate shape and an annular shape. The inner projecting portion 392 projects on the side of the circular plate-shaped portion 112D in the axial direction of the main body portion 391 from the inner peripheral side of the main body portion 391. The outer peripheral surface of the inner projecting portion 392 is a tapered surface with a smaller diameter as it is further separated from the main body portion 391 in the axial direction. A plurality of passage holes 355E (first hole portions) that are similar to the plurality of passage holes 355 and a plurality of passage holes 356E (first hole portions) that are similar to the plurality of passage holes 356 are formed in the main body portion 391 between the inner projecting portion 392 and the tubular portion 385 in its radial direction.

The inner member 381 is made of metal and is seamlessly and integrally formed. The inner member 381 has an annular shape and is formed through sintering. The maximum outer diameter of the inner member 381 is equivalent to the maximum outer diameter of the inner projecting portion 392. The inner member 381 allows the attachment shaft portion 28 of the piston rod 21 to be fitted on the inner peripheral side. Chamfering is formed on both sides of the outer peripheral surface of the inner member 381 in the axial direction. The passage forming disc 361E abuts the inner member 381 on the side opposite to the base portion 111E in the axial direction. The plurality of discs 363 are laminated on the passage forming disc 361E on the side opposite to the inner member 381 in the axial direction. The outer diameter of the passage forming disc 361E is larger than the outer diameter of the inner member 381. The maximum inner diameter of the notch portion 371 in the passage forming disc 361E is equivalent to the outer diameter of the inner member 381. The position of the passage forming disc 361E in the axial direction overlaps the circular plate-shaped portion 112D. Outer diameters of all of the plurality of discs 363 are smaller than the maximum inner diameter of the notch portion 371 in the passage forming disc 361E.

An accommodating recessed portion 351E (accommodating portion) that is substantially similar to the accommodating recessed portion 351 is formed by being surrounded by the tubular portion 385, the main body portion 391, the inner projecting portion 392, and the inner member 381. The passage holes 355E and 356E are disposed at positions in the bottom portion of the accommodating recessed portion 351E. The accommodating recessed portion 351E is provided with an elastically deformable seal member 171D (first portion) and an elastically deformable spring disc 401 (second portion). The seal member 171D and the spring disc 401 configure a movable portion 405.

The spring disc 401 is made of metal. The spring disc 401 has a flat plate shape with a constant thickness and has an annular shape. The spring disc 401 is bendable and is formed through press molding from a plate material. An inner peripheral site of the spring disc 401 on the inner side in the radial direction is sandwiched between the inner member 381 and the inner projecting portion 392 of the pilot case main body 350E. Therefore, displacement in the axial direction of the inner peripheral site of the spring disc 401 on the inner side in the radial direction is restricted. The spring disc 401 allows the attachment shaft portion 28 of the piston rod 21 to be fitted on its inner peripheral side. The spring disc 401 spreads further outward in the radial direction than the inner member 381 and the inner projecting portion 392. Displacement in the axial direction of the outer site of the spring disc 401, which is a part on the outer side in the radial direction, is allowed. A disc hole 402 (second hole portion) is formed in the spring disc 401 further outward in the radial direction than the surfaces of the inner member 381 and the inner projecting portion 392 abutting the spring disc 401. The disc hole 402 penetrates through the spring disc 401 in the axial direction of the spring disc 401.

A seal accommodating chamber 151E is formed by being surrounded by the passage forming disc 361E and the accommodating recessed portion 351E. The seal accommodating chamber 151E is formed inside the accommodating recessed portion 351E and has an annular shape. The upper chamber-side passage 161D including the throttle 152D in the passage forming disc 361E establishes communication between the upper chamber 19 (see FIG. 2) and the seal accommodating chamber 151E. The part inside the passage holes 355E and 356E and between the piston 18 and the pilot case main body 350E serves as a lower chamber-side passage 153E that establishes communication between the lower chamber 20 and the seal accommodating chamber 151E. The spring disc 401 on the outer peripheral side is disposed inside the seal accommodating chamber 151E. The spring disc 401 has a clearance in the radial direction between the spring disc 401 itself and the tubular portion 385. The spring disc 401 has a lower rigidity and is more easily deformed than the passage forming disc 361E.

The seal member 171D is accommodated in the seal accommodating chamber 151E. At that time, the seal member 171D is disposed between the spring disc 401 and the passage forming disc 361E. The seal member 171D comes into contact with the outer peripheral portion of the inner member 381 which is an inner wall portion of the accommodating recessed portion 351E and the inner peripheral portion of the tubular portion 385 which is an outer wall portion of the accommodating recessed portion 351E on the outer side in the radial direction at the same time. At that time, the seal member 171D is elastically deformed in the radial direction of the seal member 171D. The seal member 171D moves in the axial direction of the seal member 171D inside the seal accommodating chamber 151D. The seal member 171D is elastically deformed in the axial direction of the seal member 171D inside the seal accommodating chamber 151D. The seal portion 181D of the seal member 171D comes into contact with the outer peripheral portion of the inner member 381 and seals the part between the seal portion 181D itself and the outer peripheral portion. The seal portion 182D of the seal member 171D comes into contact with the inner peripheral portion of the tubular portion 385 and seals the part between the seal portion 182D itself and the inner peripheral portion. Both the seal portions 181D and 182D are provided in the seal accommodating chamber 151E.

The seal portions 181D and 182D of the seal member 171D curb flowing of the oil liquid from the side of the upper chamber-side passage 161D including the throttle 152D toward the lower chamber-side passage 153E. The seal portions 181D and 182D also curb flowing of the oil liquid from the side of the lower chamber-side passage 153E toward the upper chamber-side passage 161D. The seal member 171D sections the inside of the seal accommodating chamber 151E into an upper chamber communication chamber 185E and a lower chamber communication chamber 186E. The upper chamber communication chamber 185E communicates with the upper chamber-side passage 161D. The lower chamber communication chamber 186E communicates with the lower chamber-side passage 153E. The pressure receiving portion 183D forms the upper chamber communication chamber 185E. The pressure receiving portion 184D forms the lower chamber communication chamber 186E. The part between the circular plate-shaped portion 112D of the pilot case main body 350E and the passage forming disc 361E serves as a passage 142E. The upper chamber communication chamber 185E communicates with the passage 142E. The seal member 171D blocks communication between the side of the throttle 152D and the passage 142E and the lower chamber-side passage 153E.

The seal accommodating chamber 151E, the seal member 171D, and the spring disc 401 in the damping force generation mechanism 190E configure a frequency sensitive mechanism 191E that is sensitive to the frequency of reciprocation of the piston 18 and makes a damping force variable. The damping force generation mechanism 190E is also an accumulator. The frequency sensitive mechanism 191E communicates with the upper chamber 19 via the upper chamber-side passage 161D. The frequency sensitive mechanism 191E communicates with the lower chamber 20 via the lower chamber-side passage 153E. The seal accommodating chamber 151E, the seal member 171D, and the spring disc 401 are accommodated inside the recessed portion 58 of the piston 18 in the frequency sensitive mechanism 191E as well.

The pilot case main body 350E, the passage forming disc 361E, and the plurality of discs 363 of the pilot case 91E and the damping valve main body 201 form a pilot chamber 221E. In other words, the pilot chamber 221E is formed in the pilot case 91E. The throttle 152D communicates with the upper chamber communication chamber 185E and the pilot chamber 221E. A damping force generation unit 193E includes the damping valve 203, the disc 204, the seat forming member 205, and the pilot chamber 221E. The damping force generation unit 193E is provided on the side opposite to the piston 18 in the axial direction of the pilot case 91E. The pilot chamber 221E causes the damping valve 203 to generate a force in a direction in which the flow path area between the damping valve 203 and the valve seat portion 233 decreases, using the pressure inside the pilot chamber 221E. The pilot chamber 221E communicates with the upper chamber communication chamber 185E via the throttle 152D and the passage 142E. In this manner, the pressures of the pilot chamber 221E and the upper chamber communication chamber 185E become substantially the same.

The pilot case 91E causes the damping valve 203 having a bottomed tubular shape and disposed on the side of the opening 145 to generate a biasing force in the valve closing direction. The piston 18 is provided on the side of the case bottom portion 92E out of the case bottom portion 92E and the case tubular portion 93 in the axial direction of the pilot case 91E. The frequency sensitive mechanism 191E is provided between the piston 18 and the damping valve 203. The frequency sensitive mechanism 191E includes the movable portion 405 movably provided therein to make a biasing force to the damping valve 203 variable.

The passage forming disc 361E supports the movable portion 405 on one side (the side opposite to the piston 18). The pilot case 91E includes the accommodating recessed portion 351E to accommodate the movable portion 405. The movable portion 405 includes the elastically deformable seal member 171D and the plate-shaped spring disc 401, which comes into contact with a surface of the seal member 171D on the other side (the side of the piston 18), at least an outer site that is a part on the outer side in the radial direction of which is allowed to be displaced in the axial direction. Displacement in the axial direction of an inner site of the spring disc 401 disposed further inward than the outer site in the radial direction is restricted. The pilot case 91E includes passage holes 355E and 356E that are provided in the spring disc 401 on the other side (the side of the piston 18) and can communicate with the outside. The spring disc 401 includes a disc hole 402 that establishes communication between the accommodating recessed portion 351E and the passage holes 355E and 356E. The pilot case 91E is split into the inner member 381 located on the one side (the side opposite to the piston 18) and the pilot case main body 350E, at least a part of which is located on the other side (the side of the piston 18) as compared with the inner member 381. The passage holes 355E and 356E are provided to penetrate through the pilot case main body 350E in the axial direction of the pilot case main body 350E.

A hydraulic circuit diagram of a peripheral part of the piston 18 in the buffer 1E with the aforementioned configuration is similar to that of the buffer 1 illustrated in FIG. 4. The damping force generation mechanism 190E is actuated substantially similarly to the damping force generation mechanism 190D. In the damping force generation mechanism 190E, the oil liquid from the upper chamber 19 is introduced from the upper chamber-side passage 161D to the upper chamber communication chamber 185E in the extending process when the piston frequency is high. Then, in accordance with this, the seal member 171D receives the pressure of the oil liquid on the side of the upper chamber-side passage 161D by the pressure receiving portion 183D while blocking the communication between the upper chamber-side passage 161D and the lower chamber-side passage 153E with the seal portions 181D and 182D. In this manner, the seal member 171D is deformed while moving in the direction of the bottom portion of the accommodating recessed portion 351. At that time, the seal member 171D causes the spring disc 401 to be deformed in the direction of the bottom portion of the accommodating recessed portion 351. When the piston frequency is high, the seal member 171D moves and is deformed in this manner, and the spring disc 401 is deformed, to thereby cause the oil liquid to flow from the upper chamber 19 to the upper chamber communication chamber 185E every time the extending process is performed.

On the other hand, in the extending process when the piston frequency is low, more oil liquid is introduced from the upper chamber-side passage 161D to the upper chamber communication chamber 185E in the initial stage of the extending process than when the piston frequency is high. Then, the seal member 171D significantly moves and is deformed on the side of the bottom portion of the accommodating recessed portion 351 and causes the spring disc 401 to be significantly deformed in the direction of the bottom portion of the accommodating recessed portion 351. Thereafter, the spring disc 401 abuts the bottom portion of the accommodating recessed portion 351 and is brought into a state where deformation is restricted, and the seal member 171D is also brought into a state where movement and deformation are restricted. In this manner, the flowing of the oil liquid from the upper chamber 19 to the upper chamber communication chamber 185E is stopped. Note that the seal member 171D blocks the communication between the upper chamber-side passage 161D and the lower chamber-side passage 153E at this time as well.

Also, in the contracting process when the piston frequency is high, the oil liquid is introduced from the lower chamber 20 to the lower chamber communication chamber 186E via the lower chamber-side passage 153E. Then, the seal member 171D receives the pressure of the oil liquid on the side of the lower chamber-side passage 153D by the pressure receiving portion 184D while blocking the communication between the lower chamber-side passage 153E and the upper chamber-side passage 161D with the seal portions 181D and 182D. In this manner, the seal member 171D is deformed while moving toward the passage forming disc 361E. When the piston frequency is high, the seal member 171D moves and is deformed in this manner to cause the oil liquid to flow from the lower chamber 20 to the lower chamber communication chamber 186E every time the contracting process is performed.

On the other hand, in the contracting process when the piston frequency is low, more oil liquid flows to the lower chamber communication chamber 186E via the lower chamber-side passage 153E in the initial stage of the contracting process than when the piston frequency is high. Then, the seal member 171D significantly moves and is deformed on the side of the passage forming disc 361E and is then brought into a state where the movement and the deformation are restricted by the passage forming disc 361E. In this manner, the flowing of the oil liquid from the lower chamber 20 to the lower chamber communication chamber 186E is stopped. The seal member 171D blocks the communication between the upper chamber-side passage 161D and the lower chamber-side passage 153E in the contracting process when the piston frequency is low as well.

In the damping force generation mechanism 190E according to the sixth embodiment, the movable portion 405 of the frequency sensitive mechanism 191E includes the elastically deformable seal member 171D and the plate-shaped spring disc 401, which comes into contact with the surface of the seal member 171D on the side of the piston 18, the outer site that is a part on the outer side in the radial direction of which is allowed to be displaced in the axial direction. Therefore, the characteristic of the frequency sensitive mechanism 191E in the damping force generation mechanism 190E does not depend only on the characteristic of the seal member 171D. Therefore, according to the damping force generation mechanism 190E, it is possible to curb a temporal change in the characteristic of the frequency sensitive mechanism 191E and a variation in characteristic of the frequency sensitive mechanism 191E due to an influence of a temperature and the like.

The damping force generation mechanism 190E can enlarge the amount of variation in volume of the seal accommodating chamber 151E of the frequency sensitive mechanism 191E. Therefore, the damping force generation mechanism 190E can enlarge the flow path areas of the throttle 77 and the throttle 152D. Therefore, the damping force generation mechanism 190E can curb a variation in characteristic of the frequency sensitive mechanism 191E.

The damping force generation mechanism 190E can change the characteristic of the frequency sensitive mechanism 191E by changing the spring disc 401. Therefore, the damping force generation mechanism 190E can improve tunability.

Displacement in the axial direction of the inner site of the spring disc 401 disposed further inward in the radial direction than the outer site is restricted. Therefore, the damping force generation mechanism 190E can stabilize the characteristic of the spring disc 401 and can stabilize the characteristic of the frequency sensitive mechanism 191E.

The spring disc 401 includes the disc hole 402 that establishes communication between the accommodating recessed portion 351E and the passage holes 355E and 356E. Therefore, the damping force generation mechanism 190E can discharge air inside the accommodating recessed portion 351E from the disc hole 402 via the passage holes 355E and 356E at the time of injection of the oil liquid.

The pilot case 91E is split into the inner member 381 located on the side opposite to the piston 18 and the pilot case main body 350E, at least a part of which is located on the side of the piston 18 as compared with the inner member 381. Therefore, the damping force generation mechanism 190E enables the spring disc 401 to be easily assembled.

### Seventh Embodiment

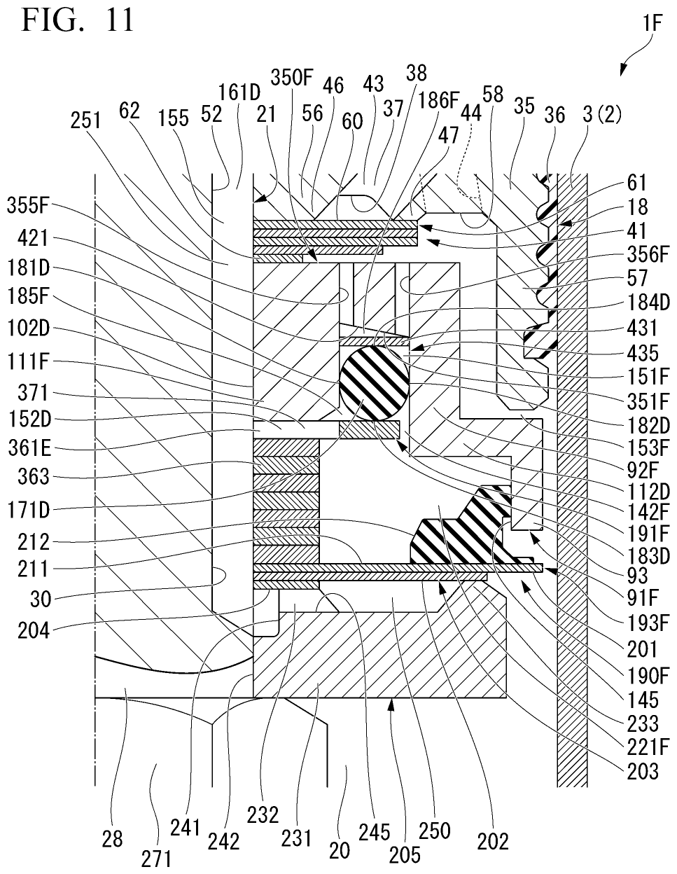

A buffer including a damping force generation mechanism according to a seventh embodiment of the present invention will be described by focusing on differences from the fifth and sixth embodiments mainly on the basis of FIG. 11. Note that sites that are common to those in the fifth and sixth embodiments will be denoted by the same names and the same reference signs.

As illustrated in FIG. 11, in a buffer 1F including a damping force generation mechanism 190F according to the seventh embodiment, the damping force generation mechanism 190F includes a pilot case 91F (biasing force generation member) that is partially different from the pilot case 91D instead of the pilot case 91D. The pilot case 91F includes a pilot case main body 350F that is partially different from the pilot case main body 350, the passage forming disc 361E, and the plurality of discs 363. The pilot case 91F is not provided with the reinforcing disc 362.

The pilot case main body 350F includes a case bottom portion 92F (bottom portion) that is partially different from the case bottom portion 92D instead of the case bottom portion 92D. The case bottom portion 92F includes a base portion 111F that is partially different from the base portion 111D instead of the base portion 111D. The case bottom portion 92F abuts the intervening disc 62 at the base portion 111F. The pilot case main body 350F allows the attachment shaft portion 28 of the piston rod 21 to be fitted into the hole portion 102D of the base portion 111F.

An accommodating recessed portion 351F (accommodating portion) that is partially different from the accommodating recessed portion 351 is formed instead of the accommodating recessed portion 351 in the base portion 111F. A bottom surface 421 of the accommodating recessed portion 351F is a tapered surface. The bottom surface 421 is further inclined toward the outer side in the radial direction to approach the circular plate-shaped portion 112D in the axial direction. A plurality of passage holes 355F (first hole portions) that are similar to the plurality of passage holes 355 and a plurality of passage holes 356F (first hole portions) that are similar to the plurality of passage holes 356 are formed at positions in the bottom surface 421 of the base portion 111F. The accommodating recessed portion 351F is provided with the elastically deformable seal member 171D (first portion) and the elastically deformable spring disc 431 (second portion). The seal member 171D and the spring disc 431 configure the movable portion 435.

The spring disc 431 is made of metal. The spring disc 431 has a flat plate shape with a constant thickness and has an annular shape. The spring disc 431 is bendable and is formed through press molding from a plate material. The spring disc 431 is disposed inside the accommodating recessed portion 351F. A seal accommodating chamber 151F is formed by being surrounded by the passage forming disc 361E and the accommodating recessed portion 351F of the pilot case main body 350F. The seal accommodating chamber 151F is formed inside the accommodating recessed portion 351F and has an annular shape. The upper chamber-side passage 161D including the throttle 152D of the passage forming disc 361E establishes communication between the upper chamber 19 (see FIG. 2) and the seal accommodating chamber 151F. The parts inside the passage holes 355F and 356F and between the piston 18 and the pilot case main body 350F serves as a lower chamber-side passage 153F that establishes communication between the lower chamber 20 and the seal accommodating chamber 151F. The entire spring disc 431 is disposed inside the seal accommodating chamber 151F. The spring disc 431 moves in the axial direction of the seal accommodating chamber 151F inside the seal accommodating chamber 151F. The spring disc 431 has lower rigidity and is more easily deformed than the passage forming disc 361E.

The seal member 171D is accommodated in the seal accommodating chamber 151F. At that time, the seal member 171D is disposed between the spring disc 431 and the passage forming disc 361E. The seal member 171D comes into contact with the inner wall portion of the accommodating recessed portion 351F and the outer wall portion of the accommodating recessed portion 351F at the same time. At that time, the seal member 171D is elastically deformed in the radial direction of the seal member 171D. The seal member 171D moves in the axial direction of the seal member 171D inside the seal accommodating chamber 151F. The seal member 171D is elastically deformed in the axial direction of the seal member 171D inside the seal accommodating chamber 151F. The seal portion 181D of the seal member 171D comes into contact with the inner wall portion of the accommodating recessed portion 351F and seals the part between the seal portion 181D itself and the inner wall portion. The seal portion 182D of the seal member 171D comes into contact with the outer wall portion of the accommodating recessed portion 351F and seals the part between the seal portion 182D itself and the outer wall portion. Both the seal portions 181D and 182D are provided in the seal accommodating chamber 151F.

The seal portions 181D and 182D of the seal member 171D curb flowing of the oil liquid from the side of the upper chamber-side passage 161D including the throttle 152D toward the lower chamber-side passage 153F. The seal portions 181D and 182D also curb flowing of the oil liquid from the side of the lower chamber-side passage 153F toward the upper chamber-side passage 161D. The seal member 171D sections the inside of the seal accommodating chamber 151F into an upper chamber communication chamber 185F and a lower chamber communication chamber 186F. The upper chamber communication chamber 185F communicates with the upper chamber-side passage 161D. The lower chamber communication chamber 186F communicates with the lower chamber-side passage 153E. The pressure receiving portion 183D forms the upper chamber communication chamber 185F. The pressure receiving portion 184D forms the lower chamber communication chamber 186F. The position of the passage forming disc 361E in the axial direction overlaps the circular plate-shaped portion 112D of the pilot case main body 350F. The part between the passage forming disc 361E and the circular plate-shaped portion 112D serves as a passage 142F. The upper chamber communication chamber 185F communicates with the throttle 152D and the passage 142F. The seal member 171D blocks communication between the side of the throttle 152D and the passage 142F and the lower chamber-side passage 153F.

The seal accommodating chamber 151F, the seal member 171D, and the spring disc 431 of the damping force generation mechanism 190F configure a frequency sensitive mechanism 191F that is sensitive to the frequency of reciprocation of the piston 18 and makes a damping force variable. The damping force generation mechanism 190F is also an accumulator. The frequency sensitive mechanism 191F communicates with the upper chamber 19 via the upper chamber-side passage 161D. The frequency sensitive mechanism 191F communicates with the lower chamber 20 via the lower chamber-side passage 153F. The seal accommodating chamber 151F, the seal member 171D, and the spring disc 431 in the frequency sensitive mechanism 191F are also accommodated inside the recessed portion 58 of the piston 18.

The pilot case main body 350F, the passage forming disc 361E, and the plurality of discs 363 of the pilot case 91F and the damping valve main body 201 form a pilot chamber 221F. In other words, the pilot chamber 221F is formed in the pilot case 91F. The throttle 152D communicates with the upper chamber communication chamber 185F and the pilot chamber 221F. The damping force generation unit 193F includes the damping valve 203, the disc 204, the seat forming member 205, and the pilot chamber 221F. The damping force generation unit 193F is provided on the side opposite to the piston 18 in the axial direction of the pilot case 91F. The pilot chamber 221F causes the damping valve 203 to generate a force in a direction in which the flow path area between the damping valve 203 and the valve seat portion 233 decreases, using the pressure inside the pilot chamber 221F. The pilot chamber 221F communicates with the upper chamber communication chamber 185F via the throttle 152D and the passage 142F. In this manner, the pressures in the pilot chamber 221F and the upper chamber communication chamber 185F become substantially the same.

The pilot case 91F causes the damping valve 203 having a bottomed tubular shape and disposed on the side of the opening 145 to generate a biasing force in the valve closing direction. The piston 18 is provided on the side of the case bottom portion 92F out of the case bottom portion 92F and the case tubular portion 93 in the axial direction of the pilot case 91F. The frequency sensitive mechanism 191F is provided between the piston 18 and the damping valve 203. The frequency sensitive mechanism 191F includes the movable portion 435 movably provided therein and makes a biasing force to the damping valve 203 variable.

The passage forming disc 361E supports the movable portion 435 on one side (the side opposite to the piston 18). The pilot case 91F includes the accommodating recessed portion 351F to accommodate the movable portion 435. The movable portion 435 includes the elastically deformable seal member 171D and the plate-shaped spring disc 431, which comes into contact with the surface of the seal member 171D on the other side (the side of the piston 18), the entire of which is allowed to be displaced in the axial direction. The pilot case 91F includes passage holes 355F and 356F that are provided in the spring disc 431 on the other side (the side of the piston 18) and can communicate with the outside.

A hydraulic circuit diagram of a peripheral part of the piston 18 in the buffer 1F with the aforementioned configuration is similar to that of the buffer 1 illustrated in FIG. 4. The damping force generation mechanism 190F is actuated substantially similarly to the damping force generation mechanism 190D. In the damping force generation mechanism 190F, the oil liquid from the upper chamber 19 is introduced from the upper chamber-side passage 161D to the upper chamber communication chamber 185F in the extending process when the piston frequency is high. Then, in accordance with this, the seal member 171D receives the pressure of the oil liquid on the side of the upper chamber-side passage 161D by the pressure receiving portion 183D while blocking the communication between the upper chamber-side passage 161D and the lower chamber-side passage 153F with the seal portions 181D and 182D. In this manner, the seal member 171D moves in the direction of the bottom surface 421 of the accommodating recessed portion 351F and is deformed while pressing the spring disc 431 against the bottom surface 421 of the accommodating recessed portion 351F. At that time, the spring disc 431 follows the bottom surface 421 and is deformed into a tapered shape. When the piston frequency is high, the seal member 171D moves and is deformed in this manner, and the spring disc 431 moves and is deformed, to thereby cause the oil liquid to flow from the upper chamber 19 to the upper chamber communication chamber 185F every time the extending process is performed.

On the other hand, in the extending process when the piston frequency is low, more oil liquid is introduced from the upper chamber-side passage 161D to the upper chamber communication chamber 185F in the initial stage of the extending process than when the piston frequency is high. Then, the seal member 171D presses the spring disc 431 against the bottom surface 421 and causes the spring disc 431 to be deformed while significantly moving and being deformed on the side of the bottom surface 421 of the accommodating recessed portion 351F. Thereafter, the spring disc 431 is brought into a state where the movement and the deformation are restricted by the bottom surface 421 of the accommodating recessed portion 351F, and the seal member 171D is also brought into a state where the movement and the deformation are restricted. In this manner, the flowing of the oil liquid from the upper chamber 19 to the upper chamber communication chamber 185F is stopped. Note that the seal member 171D blocks communication between the upper chamber-side passage 161D and the lower chamber-side passage 153F at this time as well.

Also, in the contracting process when the piston frequency is high, the oil liquid is introduced from the lower chamber 20 to the lower chamber communication chamber 186F via the lower chamber-side passage 153F. Then, the spring disc 431 moves toward the passage forming disc 361E and pressurizes the seal member 171D. Then, the seal member 171D receives the pressure of the oil liquid on the side of the lower chamber-side passage 153F by the pressure receiving portion 184D via the spring disc 431 while blocking the communication between the lower chamber-side passage 153F and the upper chamber-side passage 161D with the seal portions 181D and 182D. In this manner, the seal member 171D is deformed while moving toward the passage forming disc 361E. When the piston frequency is high, the spring disc 431 and the seal member 171D move and are deformed in this manner to cause the oil liquid to flow from the lower chamber 20 to the lower chamber communication chamber 186F every time the contracting process is performed.

On the other hand, in the contracting process when the piston frequency is low, more oil liquid flows to the lower chamber communication chamber 186F via the lower chamber-side passage 153F in the initial stage of the contracting process than when the piston frequency is high. Then, the spring disc 431 significantly moves and causes the seal member 171D to significantly moved and be deformed on the side of the passage forming disc 361E. Then, the seal member 171D is brought into a state where the movement and the deformation are restricted by the passage forming disc 361E. In this manner, the flowing of the oil liquid from the lower chamber 20 to the lower chamber communication chamber 186F is stopped. The seal member 171D blocks the communication between the upper chamber-side passage 161D and the lower chamber-side passage 153F in the contracting process when the piston frequency is low as well.

In the damping force generation mechanism 190F according to the seventh embodiment, the movable portion 435 of the frequency sensitive mechanism 191F includes the elastically deformable seal member 171D and the plate-shaped spring disc 431 that comes into contact with the surface of the seal member 171D on the side of the piston 18 and is allowed to be displaced in the axial direction. Therefore, effects similar to those in the sixth embodiment are achieved.

### Eighth Embodiment

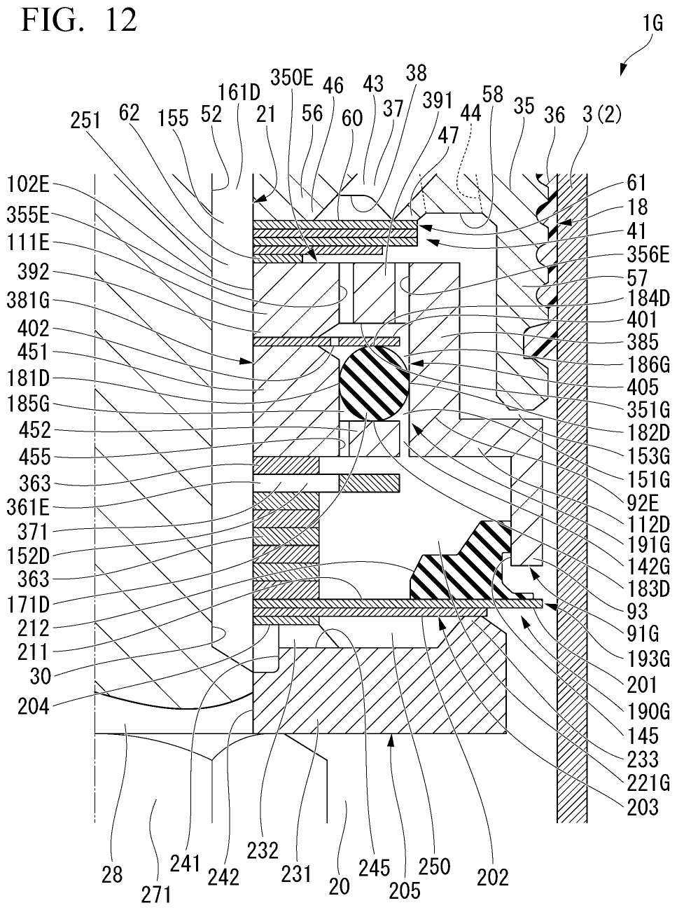

A buffer including a damping force generation mechanism according to an eighth embodiment of the present invention will be described by focusing on differences from the sixth embodiment mainly on the basis of FIG. 12. Note that sites that are common to those in the sixth embodiment will be denoted by the same names and the same reference signs.

As illustrated in FIG. 12, in a buffer 1G including a damping force generation mechanism 190G according to the eighth embodiment, the damping force generation mechanism 190G includes a pilot case 91G (biasing force generation member) that is partially different from the pilot case 91E instead of the pilot case 91E. The pilot case 91G includes an inner member 381G (one-side portion) that is partially different from the inner member 381 instead of the inner member 381.

The inner member 381G is made of metal and is seamlessly and integrally formed through sintering. The inner member 381G has an annular shape. The inner member 381G is formed through sintering. The inner member 381G includes an inner configuration portion 451 and a support portion 452. The inner configuration portion 451 is substantially similar to the inner member 381. Chamfering is formed in the inner configuration portion 451 only on the side of the spring disc 401 out of both sides of the outer peripheral surface in the axial direction. The support portion 452 spreads outward in the radial direction of the inner configuration portion 451 from an end portion on the side opposite to the spring disc 401 in the axial direction of the inner configuration portion 451. A passage hole 455 is formed at an inner end portion of the support portion 452 on the side of the inner configuration portion 451 in its radial direction. The passage hole 455 penetrates through the support portion 452 in the axial direction of the support portion 452. The pilot case 91G allows one disc 363 to be interposed between the passage forming disc 361E and the inner member 381G. The inner member 381G allows the attachment shaft portion 28 of the piston rod 21 to be fitted on the inner peripheral side. The position of the support portion 452 of the pilot case 91G overlaps the circular plate-shaped portion 112D of the pilot case main body 350E in the axial direction.

An accommodating recessed portion 351G (accommodating portion) that is substantially similar to the accommodating recessed portion 351E is formed by being surrounded by the tubular portion 385, the main body portion 391, the inner projecting portion 392, and the inner configuration portion 451. The inner peripheral site of the spring disc 401 on the inner side in the radial direction is sandwiched between the inner configuration portion 451 of the inner member 381G and the inner projecting portion 392 of the pilot case main body 350E. The spring disc 401 spreads further outward in the radial direction than the inner configuration portion 451 and the inner projecting portion 392.

A seal accommodating chamber 151G that is substantially similar to the seal accommodating chamber 151E is formed by being surrounded by the support portion 452 of the inner member 381G and the accommodating recessed portion 351G. The seal accommodating chamber 151G is formed inside the accommodating recessed portion 351G.

The pilot case main body 350E, the inner member 381G, the passage forming disc 361E, and the plurality of discs 363 of the pilot case 91G and the damping valve main body 201 form the pilot chamber 221G. In other words, the pilot chamber 221G is formed in the pilot case 91G. The throttle 152D inside the passage forming disc 361E communicates with the pilot chamber 221G. The part between the circular plate-shaped portion 112D of the pilot case main body 350E and the support portion 452 of the inner member 381G serves as a passage 142G. The seal accommodating chamber 151G communicates with the pilot chamber 221G via the passage inside the passage hole 455 and the passage 142G. The passage inside the passage hole 455 curbs the part between a corner portion between the inner configuration portion 451 and the support portion 452 and the seal member 171D becoming a tightly closed space when the seal member 171D abuts the support portion 452.

The upper chamber-side passage 161D including the throttle 152D of the passage forming disc 361E establishes communication between the upper chamber 19 (see FIG. 2) and the pilot chamber 221G. The part inside the passage holes 355E and 356E and between the piston 18 and the pilot case main body 350G serves as a lower chamber-side passage 153G that establishes communication between the lower chamber 20 and the seal accommodating chamber 151G.

The seal portions 181D and 182D of the seal member 171D curb flowing of the oil liquid flowing from the side of the upper chamber-side passage 161D including the throttle 152D toward the lower chamber-side passage 153G via the pilot chamber 221G, the passage inside the passage hole 455, and the passage 142G. The seal portions 181D and 182D also curb flowing of the oil liquid from the side of the lower chamber-side passage 153G toward the pilot chamber 221G and the upper chamber-side passage 161D. The seal member 171D sections the inside of the seal accommodating chamber 151G into an upper chamber communication chamber 185G and a lower chamber communication chamber 186G. The upper chamber communication chamber 185G communicates with the upper chamber-side passage 161D via the passage inside the passage hole 455, the passage 142G, and the pilot chamber 221G. The lower chamber communication chamber 186G communicates with the lower chamber-side passage 153G. The pressure receiving portion 183D forms the upper chamber communication chamber 185G. The pressure receiving portion 184D forms the lower chamber communication chamber 186G.

In the damping force generation mechanism 190G, the seal accommodating chamber 151G, the seal member 171D, and the spring disc 401 configure a frequency sensitive mechanism 191G that is sensitive to the frequency of reciprocation of the piston 18 and makes a damping force variable. The damping force generation mechanism 190G is also an accumulator. The frequency sensitive mechanism 191G communicates with the upper chamber 19 via the passage inside the passage hole 455, the passage 142G, the pilot chamber 221G, and the upper chamber-side passage 161D. The frequency sensitive mechanism 191G communicates the lower chamber 20 via the lower chamber-side passage 153G. The seal accommodating chamber 151G, the seal member 171D, and the spring disc 401 of the frequency sensitive mechanism 191G are also accommodated inside the recessed portion 58 of the piston 18. The pressures in the pilot chamber 221G and the upper chamber communication chamber 185G are set to be substantially the same by the passage inside the passage hole 455 and the passage 142G.

A damping force generation unit 193G includes the damping valve 203, the disc 204, the seat forming member 205, and the pilot chamber 221G. The damping force generation unit 193G is provided on the side opposite to the piston 18 in the axial direction of the pilot case 91G. The pilot chamber 221G causes the damping valve 203 to generate a force in the direction in which the flow path area between the damping valve 203 and the valve seat portion 233 decreases, using the pressure inside the pilot chamber 221G.

The pilot case 91G causes the damping valve 203 having a bottomed tubular shape and disposed on the side of the opening 145 to generate a biasing force in the valve closing direction. The piston 18 is provided on the side of the case bottom portion 92E out of the case bottom portion 92E and the case tubular portion 93 in the axial direction of the pilot case 91G. The frequency sensitive mechanism 191G is provided between the piston 18 and the damping valve 203. The frequency sensitive mechanism 191G includes a movable portion 405 movable provided therein and makes a biasing force to the damping valve 203 variable. The support portion 452 supporting the movable portion 405 on one side (the side opposite to the piston 18) is formed integrally with the inner member 381G.

A hydraulic circuit diagram of a peripheral part of the piston 18 in the buffer 1G with the aforementioned configuration is similar to that of the buffer 1 illustrated in FIG. 4. The damping force generation mechanism 190G is actuated substantially similarly to the damping force generation mechanism 190E. At that time, the oil liquid from the upper chamber 19 is introduced from the upper chamber-side passage 161D to the upper chamber communication chamber 185G via the pilot chamber 221G, the passage inside the passage hole 455, and the passage 142G in the extending process in the damping force generation mechanism 190G. Also, in the contracting process, the oil liquid is introduced from the lower chamber 20 to the lower chamber communication chamber 186G via the lower chamber-side passage 153G.

In the damping force generation mechanism 190G according to the eighth embodiment, the support portion 452 supporting the movable portion 405 on the side opposite to the piston 18 is formed integrally with the inner member 381G. Therefore, it is possible to reduce the number of components and to reduce the number of assembling processes.

### Ninth Embodiment

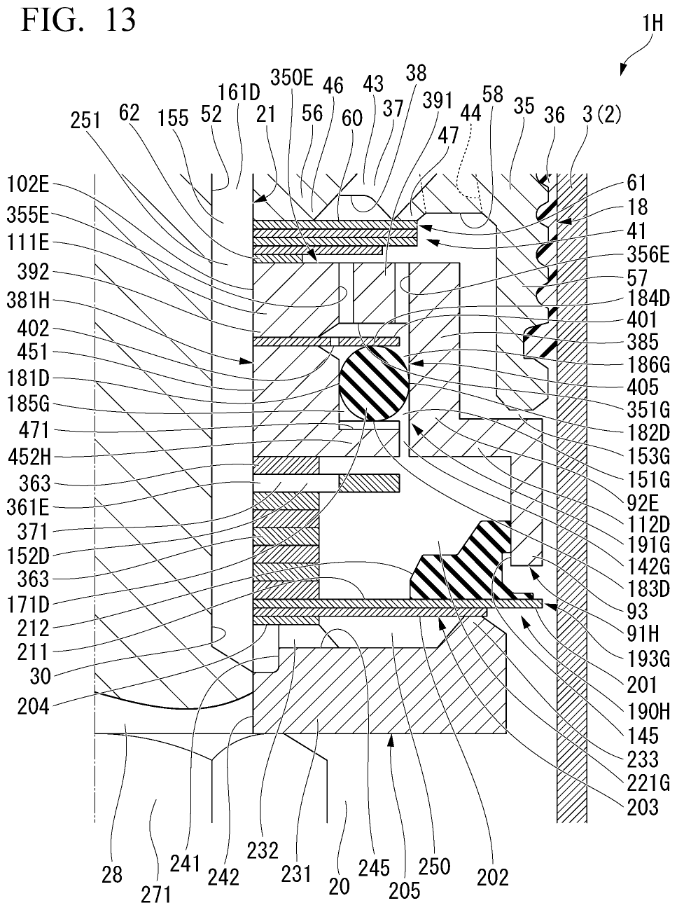

A buffer including a damping force generation mechanism according to a ninth embodiment of the present invention will be described by focusing on differences from the eighth embodiment mainly on the basis of FIG. 13. Note that sites that are common to those in the eighth embodiment will be denoted by the same names and the same reference signs.

As illustrated in FIG. 13, in a buffer 1H including a damping force generation mechanism 190H according to the ninth embodiment, the damping force generation mechanism 190H includes a pilot case 91H (biasing force generation member) that is partially different from the pilot case 91G instead of the pilot case 91G. The pilot case 91H includes an inner member 381H (one-side portion) that is partially different from the inner member 381G instead of the inner member 381G. The inner member 381H is seamlessly and integrally formed through sintering.

The inner member 381H includes a support portion 452H that is partially different from the support portion 452. The passage hole 455 is not formed in the support portion 452H. The passage groove 471 is formed in the support portion 452H. The passage groove 471 is formed on the side of the movable portion 405 in the axial direction of the support portion 452H. The passage groove 471 extends in the radial direction of the support portion 452H. The upper chamber communication chamber 185G of the seal accommodating chamber 151G communicates with the pilot chamber 221G via the passage 142G. Also, even if the seal member 171D abuts the support portion 452H, the entire upper chamber communication chamber 185G communicates with the passage 142G via the passage inside the passage groove 471. In other words, the passage inside the passage groove 471 curbs the part between the corner portion between the inner configuration portion 451 and the support portion 452H and the seal member 171D becoming a tightly closed space when the seal member 171D abuts the support portion 452H.

In the damping force generation mechanism 190H, the frequency sensitive mechanism 191G communicates with the upper chamber 19 via the passage 142G, the pilot chamber 221G, and the upper chamber-side passage 161D. The pressures in the pilot chamber 221G and the upper chamber communication chamber 185G are set to be substantially the same by the passage 142G.

A hydraulic circuit diagram of a peripheral part of the piston 18 in the buffer 1H with the aforementioned configuration is similar to that of the buffer 1 illustrated in FIG. 4. The damping force generation mechanism 190H is actuated substantially similar to the damping force generation mechanism 190G.

### Tenth Embodiment

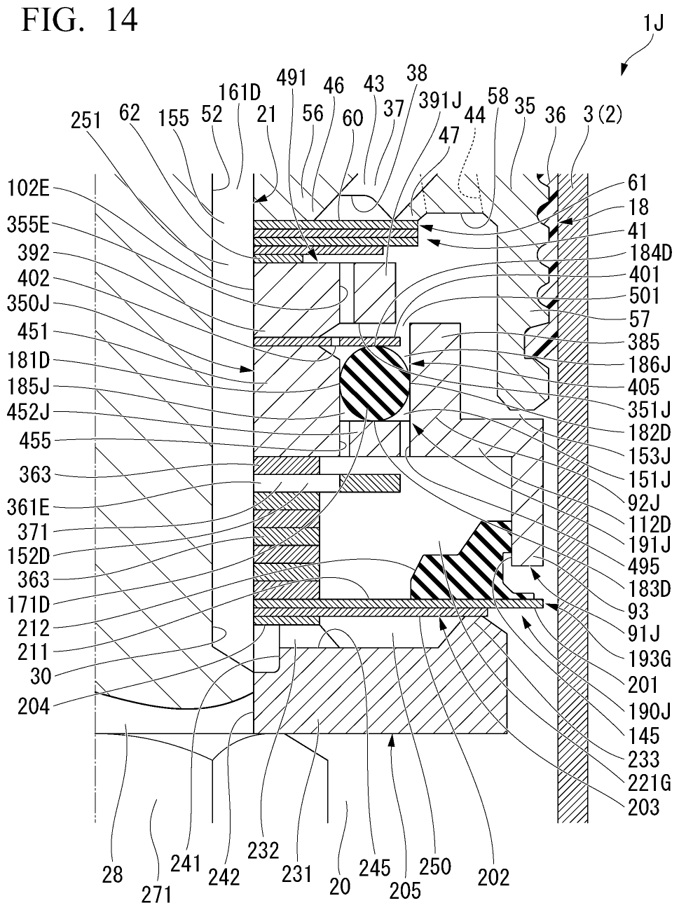

A buffer including a damping force generation mechanism according to a tenth embodiment of the present invention will be described by focusing in differences from the eighth embodiment mainly on the basis of FIG. 14. Note that sites that are common to those in the eighth embodiment will be denoted by the same names and the same reference signs.

As illustrated in FIG. 14, in a buffer 1J including a damping force generation mechanism 190J according to the tenth embodiment, the damping force generation mechanism 190J includes a pilot case 91J (biasing force generation member) that is partially different from the pilot case 91G instead of the pilot case 91G. The pilot case 91J includes a pilot case main body 350J (one-side portion) and a cover member 491 (other-side portion) instead of the pilot case main body 350E and the inner member 381G.

The pilot case main body 350J is made of metal and is seamlessly and integrally formed through sintering. The pilot case main body 350J includes the case tubular portion 93, the circular plate-shaped portion 112D, and the tubular portion 385 similarly to the pilot case main body 350E. The pilot case main body 350J is not provided with the base portion 111E. In addition, the pilot case main body 350J includes the inner configuration portion 451 that is similar to the inner member 381G and a support portion 452J that is substantially similar to the support portion 452. The support portion 452J on the outer peripheral side is connected to the circular plate-shaped portion 112D. A passage hole 495 is formed at an outer end portion of the support portion 452J on the side of the circular plate-shaped portion 112D in the radial direction. The passage hole 495 penetrates through the support portion 452J in the axial direction of the support portion 452J.

The cover member 491 is made of metal and is seamlessly and integrally formed. The cover member 491 has an annular shape and is formed through sintering. The cover member 491 includes a main body portion 391J that is substantially similar to the main body portion 391 of the pilot case main body 350E and the inner projecting portion 392. The cover member 491 abuts the intervening disc 62 at the main body portion 391J. The passage hole 356E is not formed in the main body portion 391J. The outer diameter of the main body portion 391J is smaller than the inner diameter of the tubular portion 385 of the pilot case main body 350J. The part between the main body portion 391J and the tubular portion 385 serves as a passage 501. The circular plate-shaped portion 112D, the tubular portion 385, the inner configuration portion 451, and the support portion 452J of the pilot case main body 350J configure the case bottom portion 92J (bottom portion).

An accommodating recessed portion 351J (accommodating portion) that is substantially similar to the accommodating recessed portion 351G is formed by being surrounded by the tubular portion 385, the main body portion 391J, the inner projecting portion 392, and the inner configuration portion 451. The inner peripheral site of the spring disc 401 on the inner side in the radial direction is sandwiched between the inner configuration portion 451 of the pilot case main body 350J and the inner projecting portion 392 of the cover member 491. The spring disc 401 spreads further outward in the radial direction than the inner configuration portion 451 and the inner projecting portion 392.

A seal accommodating chamber 151J that is substantially similar to the seal accommodating chamber 151G is formed by being surrounded by the support portion 452J and the accommodating recessed portion 351J of the pilot case main body 350J. The seal accommodating chamber 151J is formed inside the accommodating recessed portion 351J.

The pilot case main body 350J, the passage forming disc 361E, and the plurality of discs 363 of the pilot case 91J and the damping valve main body 201 form the pilot chamber 221G. The seal accommodating chamber 151J communicates with the pilot chamber 221G via the passage inside the passage hole 455 and the passage inside the passage hole 495.

The part between the side of the cover member 491 and the pilot case main body 350J and the piston 18 and the inside of the passage hole 355E serves as a lower chamber-side passage 153J that establishes communication between the lower chamber 20 and the seal accommodating chamber 151J. The lower chamber-side passage 153J includes the passage 501 between the pilot case main body 350J and the cover member 491.

The seal portions 181D and 182D of the seal member 171D curb flowing of the oil liquid flowing from the side of the upper chamber-side passage 161D including the throttle 152D toward the lower chamber-side passage 153J via the pilot chamber 221G and the passages inside the passage holes 455 and 495. The seal portions 181D and 182D also curb flowing of the oil liquid from the side of the lower chamber-side passage 153J toward the pilot chamber 221G and the upper chamber-side passage 161D. The seal member 171D sections the inside of the seal accommodating chamber 151J into an upper chamber communication chamber 185J and a lower chamber communication chamber 186J. The upper chamber communication chamber 185J communicates with the upper chamber-side passage 161D via the passages inside the passage holes 455 and 495 and the pilot chamber 221G. The lower chamber communication chamber 186J communicates with the lower chamber-side passage 153J. The pressure receiving portion 183D forms the upper chamber communication chamber 185J. The pressure receiving portion 184D forms the lower chamber communication chamber 186J.

In the damping force generation mechanism 190J, the seal accommodating chamber 151J, the seal member 171D, and the spring disc 401 configure a frequency sensitive mechanism 191J that is sensitive to the frequency of reciprocation of the piston 18 and makes a damping force variable. The damping force generation mechanism 190J is also an accumulator. The frequency sensitive mechanism 191J communicates with the upper chamber 19 via the passages inside the passage holes 455 and 495, the pilot chamber 221G, and the upper chamber-side passage 161D. The frequency sensitive mechanism 191J communicates with the lower chamber 20 via the lower chamber-side passage 153J. The seal accommodating chamber 151J, the seal member 171D, and the spring disc 401 of the frequency sensitive mechanism 191J are also accommodated inside the recessed portion 58 of the piston 18. The pressures in the pilot chamber 221G and the upper chamber communication chamber 185J are set to be substantially the same by the passages inside the passage holes 455 and 495.

The pilot case 91J causes the damping valve 203 having a bottomed tubular shape and disposed on the side of the opening 145 to generate a biasing force in the valve closing direction. The piston 18 is provided on the side of the case bottom portion 92J out of the case bottom portion 92J and the case tubular portion 93 in the axial direction of the pilot case 91G. The frequency sensitive mechanism 191J is provided between the piston 18 and the damping valve 203. The frequency sensitive mechanism 191J includes the movable portion 405 movably provided therein and makes a biasing force to the damping valve 203 variable. The support portion 452J supporting the movable portion 405 on one side (the side opposite to the piston 18) is formed integrally with the pilot case main body 350J.

A hydraulic circuit diagram of a peripheral part of the piston 18 in the buffer 1J with the aforementioned configuration is similar to that of the buffer 1 illustrated in FIG. 4. The damping force generation mechanism 190J is actuated substantially similarly to the damping force generation mechanism 190G. At that time, the oil liquid from the upper chamber 19 is introduced from the upper chamber-side passage 161D to the upper chamber communication chamber 185J via the pilot chamber 221G and the passages inside the passage holes 455 and 495 in the extending process in the damping force generation mechanism 190J. Also, the oil liquid is introduced from the lower chamber 20 to the lower chamber communication chamber 186J via the lower chamber-side passage 153J in the contracting process.

In the damping force generation mechanism 190J according to the tenth embodiment, the support portion 452J supporting the movable portion 405 on the side opposite to the piston 18 is formed integrally with the pilot case main body 350J. Therefore, it is possible to reduce the number of components and to reduce the number of assembling processes.

### Eleventh Embodiment

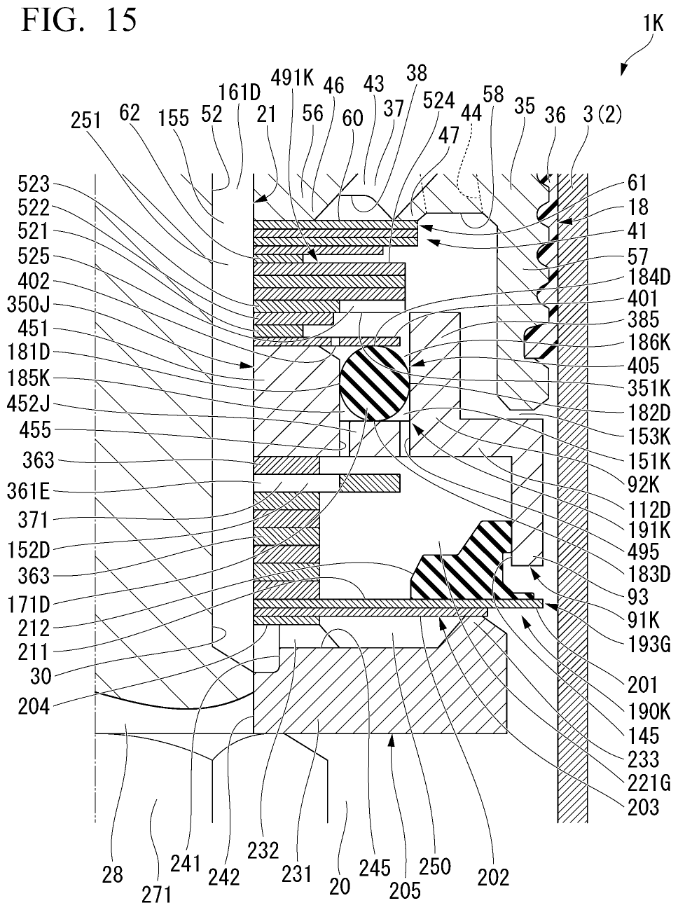

A buffer including a damping force generation mechanism according to an eleventh embodiment of the present invention will be described by focusing in differences from the tenth embodiment mainly on the basis of FIG. 15. Note that sites that are common to those in the tenth embodiment will be denoted by the same names and the same reference signs.

As illustrated in FIG. 15, in a buffer 1K including a damping force generation mechanism 190K according to the eleventh embodiment, the damping force generation mechanism 190K includes a pilot case 91K (biasing force generation member) that is partially different from the pilot case 91J instead of the pilot case 91J. The pilot case 91K is provided with a cover portion 491K (other-side portion) instead of the cover member 491. The cover portion 491K includes a disc 521, a disc 522, a passage forming disc 523 (disc), and a plurality of discs 524. The disc 521, the disc 522, the passage forming disc 523, and the plurality of discs 524 are laminated in this order from the side of the spring disc 401. The disc 521 of the cover portion 491K abuts the spring disc 401. The disc 524 on the furthest side opposite to the passage forming disc 523 from among the plurality of discs 524 of the cover portion 491K abuts the intervening disc 62.

All of the discs 521, 522, and 524 and the passage forming disc 523 are made of metal. All of the discs 521, 522, and 524 and the passage forming disc 523 have flat plate shapes with constant thicknesses and have annular shapes. All of the discs 521, 522, and 524 and the passage forming disc 523 are formed through press molding from plate materials. All of the discs 521, 522, and 524 and the passage forming disc 523 allow the attachment shaft portion 28 of the piston rod 21 to be fitted on the inner peripheral side.

The outer diameter of the disc 521 is smaller than the outer diameter of the spring disc 401. The outer diameter of the disc 522 is smaller than the outer diameter of the spring disc 401 and is larger than the outer diameter of the disc 521. The passage forming disc 523 includes a notch 525 formed to extend inward in the radial direction from its outer peripheral end edge. The maximum outer diameter of the passage forming disc 523 is larger than the outer diameter of the disc 522. The outer diameter of the disc 524 is the same as the maximum outer diameter of the passage forming disc 523. The maximum outer diameter of the passage forming disc 523 and the outer diameter of the disc 524 are slightly smaller than the inner diameter of the tubular portion 385. The circular plate-shaped portion 112D of the pilot case main body 350J, the tubular portion 385, the inner configuration portion 451, and the support portion 452J configure a case bottom portion 92K (bottom portion) of the pilot case 91K.

An accommodating recessed portion 351K (accommodating portion) that is substantially similar to the accommodating recessed portion 351J is formed by being surrounded by the discs 521, 522, and 524, the passage forming disc 523, the tubular portion 385, and the inner configuration portion 451. An inner peripheral site of the spring disc 401 on the inner side in the radial direction is sandwiched between the inner configuration portion 451 of the pilot case main body 350J and the disc 521. The spring disc 401 spreads further outward in the radial direction than the inner configuration portion 451 and the disc 521.

A seal accommodating chamber 151K that is substantially similar to the seal accommodating chamber 151J is formed by being surrounded by the support portion 452J and the accommodating recessed portion 351K of the pilot case main body 350J. The seal accommodating chamber 151K is formed inside the accommodating recessed portion 351K.

The part between the side of the cover portion 491K and the pilot case main body 350G and the piston 18 and the passage inside the notch portion 525 of the passage forming disc 523 serve as a lower chamber-side passage 153K that establishes communication between the lower chamber 20 and the seal accommodating chamber 151K.

The seal portions 181D and 182D of the seal member 171D curb flowing of the oil liquid from the side of the upper chamber-side passage 161D including the throttle 152D toward the lower chamber-side passage 153K via the pilot chamber 221G and the passages inside the passage holes 455 and 495. The seal portions 181D and 182D also curb flowing of the oil liquid from the side of the lower chamber-side passage 153K toward the pilot chamber 221G and the upper chamber-side passage 161D. The seal member 171D sections the inside of the seal accommodating chamber 151K into an upper chamber communication chamber 185K and a lower chamber communication chamber 186K. The upper chamber communication chamber 185K communicates with the upper chamber-side passage 161D via the passages inside the passage holes 455 and 495 and the pilot chamber 221G. The lower chamber communication chamber 186K communicates with the lower chamber-side passage 153K. The pressure receiving portion 183D forms the upper chamber communication chamber 185K. The pressure receiving portion 184D forms the lower chamber communication chamber 186K.

In the damping force generation mechanism 190K, the seal accommodating chamber 151K, the seal member 171D, the spring disc 401 configure the frequency sensitive mechanism 191K that is sensitive to the frequency of reciprocation of the piston 18 and makes a damping force variable. The damping force generation mechanism 190K is also an accumulator. The frequency sensitive mechanism 191K communicates with the upper chamber 19 via the passages inside the passage holes 455 and 495, the pilot chamber 221G, and the upper chamber-side passage 161D. The frequency sensitive mechanism 191K communicates with the lower chamber 20 via the lower chamber-side passage 153K. The seal accommodating chamber 151K, the seal member 171D, and the spring disc 401 of the frequency sensitive mechanism 191K are accommodated inside the recessed portion 58 of the piston 18. The pressures inside the pilot chamber 221G and the upper chamber communication chamber 185K are set to be substantially the same by the passages inside the passage holes 455 and 495.

The pilot case 91K causes the damping valve 203 having a bottomed tubular shape and disposed on the side of the opening 145 to generate a biasing force in the valve closing direction. The piston 18 is provided on the side of the case bottom portion 92K out of the case bottom portion 92K and the case tubular portion 93 in the axial direction of the pilot case 91G. The frequency sensitive mechanism 191K is provided between the piston 18 and the damping valve 203. The frequency sensitive mechanism 191K includes the movable portion 405 movably provided therein and makes a biasing force to the damping valve 203 variable.

A hydraulic circuit diagram of a peripheral part of the piston 18 in the buffer 1K with the aforementioned configuration is similar to that of the buffer 1 illustrated in FIG. 4. The damping force generation mechanism 190K is actuated substantially similarly to the damping force generation mechanism 190J. At that time, the oil liquid from the upper chamber 19 is introduced from the upper chamber-side passage 161D to the upper chamber communication chamber 185K via the pilot chamber 221G and the passages inside the passage holes 455 and 495 in the extending process in the damping force generation mechanism 190K. Also, the oil liquid is introduced from the lower chamber 20 to the lower chamber communication chamber 186K via the lower chamber-side passage 153K in the contracting process.

In the damping force generation mechanism 190K according to the eleventh embodiment, the cover portion 491K is formed by the plurality of discs 521, 522, and 524 and the passage forming disc 523 being laminated. Therefore, it is possible to curb a manufacturing cost of the cover portion 491K.

Note that although the first to eleventh embodiments have been described by exemplifying the cases where the piston 18 is provided with the damping force generation mechanisms 190, 190A to 190H, 190J, and 190K, the present invention is not limited thereto. For example, the damping force generation mechanisms 190, 190A to 190H, 190J, and 190K may be provided on the side of the base valve member 281. Also, the damping force generation mechanisms 190, 190A to 190H, 190J, and 190K may be provided outside the outer tube 4 of the cylinder 2.

### REFERENCE SIGNS LIST

1, 1A to 1H, 1J, 1K Buffer
2 Cylinder
18 Piston (regulation member)
19 Upper chamber (one-side chamber)
20 Lower chamber (other-side chamber)
21 Piston rod (shaft member)
43, 44 Piston passage (passage)
58 Recessed portion
61A Sub-valve (second damping force generation member)
81C Seal case (seating portion)
91, 91B, 91D to 91H, 91J, 91K Pilot case (biasing force generation member)
92, 92B, 92D to 92F, 92J, 92K Case bottom portion (bottom portion)
145 Opening
171, 331, 331C Seal member (movable portion)
171C Seal main body portion (elastic portion)
171D Seal member (movable portion, first portion)
190, 190A to 190H, 190J, 190K Damping force generation mechanism
191, 191A, 191B, 191D to 191H, 191J, 191K Frequency sensitive mechanism
203 Damping valve (first damping force generation member)
205 Seat forming member
233 Valve seat portion (seat)
341 Seal main body member (elastic fixing member)
342 Support disc (fixing portion)
345 First surface
346 Second surface
350E Pilot case main body (other-side portion)
350J Pilot case main body (one-side portion)
351, 351E to 351G, 351J, 351K Accommodating recessed portion (accommodating portion)
355E, 355F, 356E, 356F Passage hole (first hole portion)
361, 361E Passage forming disc (support portion)
362 Reinforcing disc (support portion)
381, 381G, 381H Inner member (one-side portion)
401, 431 Spring disc (second portion)
402 Disc bole (second bole portion)
405 Movable portion
452, 452H, 452J Support portion
491 Cover member (other-side portion)
491K Cover portion (other-side portion)
521, 522, 524 Disc
523 Passage forming disc (disc)

1. A damping force generation mechanism comprising:
a biasing force generation member that causes a first damping force generation member having a bottomed tubular shape and disposed on a side of an opening to generate a biasing force in a valve closing direction;
a regulation member that is provided on a side of a bottom portion of the biasing force generation member and includes passages formed to establish communication between a one-side chamber and an other-side chamber;
a frequency sensitive mechanism that is provided between the regulation member and the first damping force generation member, is provided with a movable portion in a movable manner, and makes the biasing force variable; and
a seat forming member that is provided at the biasing force generation member on the side of the opening and includes a seat formed therein for the first damping force generation member to be seated.

2. The damping force generation mechanism according to claim 1, wherein the regulation member is a piston that is movably inserted into a cylinder and is fixed on a side of one end of a shaft member provided along a center axis of the cylinder, includes a recessed portion that has a smaller dimension in an axial direction in a predetermined range on an inner side in a radial direction than in the other ranges, and at least partially accommodates the frequency sensitive mechanism in the recessed portion.

3. The damping force generation mechanism according to claim 1, further comprising:
a second damping force generation member that blocks an opening portion of at least one of the passages of the regulation member,
wherein a biasing force is applied to the second damping force generation member.

4. The damping force generation mechanism according to claim 1, comprising:
a support portion that supports one side of the movable portion,
wherein the biasing force generation member includes an accommodating portion that accommodates the movable portion, and
the movable portion includes
a first portion that is elastically deformable, and
a second portion with a plate shape that comes into contact with a surface of the first portion on the other side and has at least an outer section, which is a part on an outer side in a radial direction, allowed to be displaced in an axial direction.

5. The damping force generation mechanism according to claim 4, wherein displacement in the axial direction of an inner section of the second portion disposed further inward in the radial direction than the outer section is restricted.

6. The damping force generation mechanism according to claim 4,
wherein the biasing force generation member further includes a first hole portion that is provided at the second portion on the other side and is capable of communicating with the outside, and
the second portion includes a second hole portion that establishes communication between the accommodating portion and the first hole portion.

7. The damping force generation mechanism according to claim 4, wherein the biasing force generation member is split into a one-side portion that is located on the one side and an other-side portion that is at least partially located on the other side as compared with the one-side portion.

8. The damping force generation mechanism according to claim 6,
wherein the biasing force generation member is split into a one-side portion that is located on the one side and an other-side portion that is at least partially located on the other side as compared with the one-side portion, and
the first hole portion is provided to penetrate through the other-side portion in an axial direction.

9. The damping force generation mechanism according to claim 7, wherein the other-side portion is formed by stacking a plurality of discs.

10. The damping force generation mechanism according to claim 7, wherein the support portion is formed integrally with the one-side portion.

11. The damping force generation mechanism according to claim 1,
wherein the movable portion includes
an elastic fixing member that includes a fixing portion including a first surface to which an elastically deformable elastic portion is fixed, and
a seating portion that is disposed between the elastic fixing member and the regulation member and allows a second surface of the fixing portion to be seated thereon.
